(19) United States
(12) Patent Application Publication
(10) Pub. No.: US 2014/0292114 A1
(43) Pub. Date: Oct. 2, 2014

(54) Method and Apparatus for Converting Between Electrical and Mechanical Energy

(71) Applicant: E.M.I.P. PTY LTD, South Melbourne, VIC (AU)

(72) Inventor: Tony Bell, South Melbourne (AU)

(21) Appl. No.: 14/362,145

(22) PCT Filed: Nov. 30, 2012
(86) PCT No.: PCT/AU2012/001460

§ 371 Date: Jun. 2, 2014

(30) Foreign Application Priority Data
Dec. 1, 2011 (AU) 2011905005
Nov. 8, 2012 (AU) 2012101645
Nov. 8, 2012 (AU) 2012101646
Nov. 8, 2012 (AU) 2012101648
Nov. 8, 2012 (AU) 2012101649

(51) Int. Cl. H01H 47/22; H02K 7/075

(52) U.S. Cl. CPC H01H 47/22; H02K 7/075
USPC 310/23; 361/186

(57) ABSTRACT

The present application relates to conversion between electrical and mechanical energy. In preferred forms, a solenoid assembly is provided that may include a housing containing a core member and a coil assembly including at least one coil, a plunger assembly adapted for reciprocal movement within said housing between a first position and a second position, and a driver circuit for energizing the coil assembly to cause the plunger assembly to move at least between the first and second positions.

### RELATED APPLICATIONS

This application claims priority to Australian Provisional Patent Application No. 2011905005 in the name of E.M.I.P. Pty Ltd, which was filed on 1 Dec. 2011, entitled “Method and Apparatus for Converting Between Electrical and Mechanical Energy” and, Australian Innovation Patent No. 2012101645 in the name of E.M.I.P. Pty Ltd, which was filed on 8 Nov. 2012, entitled “Method and Apparatus for Converting Between Electrical and Mechanical Energy” and, Australian Innovation Patent No. 2012101646 in the name of E.M.I.P. Pty Ltd, which was filed on 8 Nov. 2012, entitled “Method and Apparatus for Converting Between Electrical and Mechanical Energy” and, Australian Innovation Patent No. 2012101648 in the name of E.M.I.P. Pty Ltd, which was filed on 8 Nov. 2012, entitled “Method and Apparatus for Converting Between Electrical and Mechanical Energy” and, Australian Innovation Patent No. 2012101649 in the name of E.M.I.P. Pty Ltd, which was filed on 8 Nov. 2012, entitled “Method and Apparatus for Converting Between Electrical and Mechanical Energy” and the specifications thereof are incorporated herein by reference in their entirety and for all purposes.

### FIELD OF INVENTION

The present invention relates to conversion between electrical and mechanical energy. In one form, the present invention relates to a means for converting electrical power to mechanical motion in an electric motor. It will be convenient to hereinafter describe the invention in relation to an electric motor such as a reciprocating motor incorporating or making use of one or more electric solenoids according to preferred embodiments of the invention, however, it should be appreciated that the present invention is not limited to that use, only.

### BACKGROUND OF INVENTION

Throughout this specification the use of the word “inventor” in singular form may be taken as reference to one (singular) inventor or more than one (plural) inventor of the present invention.

It is to be appreciated that any discussion of documents, devices, acts or knowledge in this specification is included to explain the context of the present invention. Further, the discussion throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

Various methods and apparatus are known for converting electrical energy into rotary motion. For example rotary motion is typically obtained via a conventional rotary electric motor or machine. A conventional rotary electric motor or machine includes a stator and a rotor wherein the stator provides a rotating magnetic field and the rotor interacts with the rotating field to produce a torque or rotary motion.

Conversion efficiency of a rotary electric motor being mechanical output power divided by electrical input power varies depending upon its design and capacity, but typically is not more than about 60% in, for example, a small capacity electric motor.

An electromagnetic linear actuator is disclosed in JP 2000-224826 (Denso Corp). The arrangement includes a 3-part plunger and three coils that operate continuously with currents switched progressively to each of the three coils to control motion of the plunger in its reciprocal movement. The Denso actuator has, as its objective, a means of providing an actuator with large thrust and the ability to return to a specified position when a given current is cut off. This implies that efficiency is being dispensed with in favour of substantial momentum and, it would follow, substantial changes in momentum of the plunger. Further the teeth arrangement of Denso is a complex configuration to allow the desired thrust to be built up as current is switched and with the complex configuration it is considered that friction may need to be addressed in the moving parts of the Denso design.

U.S. Pat. No. 3,832,608 (Mills) discloses an array of radially and longitudinally distinct series of shielded solenoid coils surrounding an electromagnetically susceptible movable piston and a timer assembly for sequential selective actuation of portions of the coils responsive to the position of a piston relative thereto to provide for moving the center of a magnetic field relative to the movable piston while positively maintaining the direction of a magnetization of the piston. This process and structures are aimed at avoiding creation of eddy currents and long magnetic paths through a moving element transverse to its direction of movement and reciprocating a piston without detectable heat development and utilizing a transistorized trigger current for large amperage solenoid actuating currents which avoid gas formation and arcing. It is considered that this system has inefficiencies, for example, it is noted that the moving piston is a unitary part of similar material that may affect the motion of the piston under differing current conditions in the coils.

U.S. Pat. No. 4,510,420 (Sasso) discloses a servo rotary motor utilising Pulse Width Modulation in the power generating circuitry to control timing of the current pulses to coils in an electric motor. The motor of Sasso requires a closed lubrication system to address friction of the moving parts, in particular the moving pistons. There is also a need for added cooling means to address heating in the Sasso motor.

U.S. Pat. No. 3,328,656 (Dotson) discloses a solenoid operated reciprocating engine or motor adapted for achieving a high Q factor for the coil assembly associated with a reciprocating plunger by providing a plurality of coil windings for each solenoid plunger connected in parallel. This provides an increase in the number of given Ampere turns in a given coil space by an optimum amount as compared to an increase in the coil winding resistance. Accordingly, the coil assembly is able to provide a relatively low resistance, low impedance and high current characteristic, matching a low voltage, high current source such as a storage battery. Further the cyclic supply of energising current to the coil assemblies are timed in conjunction with the connection of a high capacity storage capacitor across the paralleled windings of the coil assemblies in order to prolong the displacing force applied to the coil plungers involving both the rise and decay of magnetic flux produced by energisation and deenergisation of the coil assemblies.

U.S. Pat. No. 4,017,103 (Davis et al) discloses an electromagnetic motor and generator is disclosed having a pair of solenoids wound on a cylinder, each of said solenoids comprising three separate but connected windings. A magnetisable piston is positioned for reciprocation in the cylinder and is connected to a rotatably mounted crankshaft. A commutator connected to the crankshaft and interposed in an electric circuit selectively energizes the solenoids to cause rotary motion of the crankshaft. An additional circuit means is also provided for recapturing electrical energy generated in each of the solenoids upon deenergization of the solenoid by said switch. The commutator on the crankshaft of the motor effectively controls energising of coils. There is a need for additional circuitry also for recapturing energy generated in each solenoid upon deenergization of the solenoid.

In each of the above noted prior art systems there is at least a deficiency in that the maintenance of a working magnetic field for as long as possible without putting in additional energy during the phase(s) of the solenoid or motor cycle may not be achieved.

### SUMMARY OF INVENTION

It is an object of the embodiments described herein to overcome or alleviate at least one disadvantage or drawback of related art systems or to at least provide a useful alternative to related art systems. In contrast, the present invention may provide, in one form, an electric solenoid and/or solenoid driven electric motor or machine that at least alleviates the disadvantages of the prior art.

In various forms the present invention provides a solenoid assembly suitable for converting between electrical energy and mechanical movement, said solenoid assembly comprising:

a housing containing a core member and a coil assembly including at least one coil;

a plunger assembly adapted for reciprocal movement within said housing between a first position and a second position; and

a driver circuit for energizing said coil assembly to cause said plunger assembly to move at least between said first and second positions. The solenoid assembly may further comprise a linear bearing assembly operatively connecting the plunger assembly with the housing for aligning the reciprocal movement of the plunger assembly with a longitudinal axis of the housing. Furthermore, the linear bearing assembly preferably comprises:

at least one bracket connected to the plunger assembly;

at least one bearing block attached to the at least one bracket for accommodating at least one linear bearing;

at least one rod for slidingly engaging with the at least one linear bearing wherein the at least one rod is connected at each end thereof to the housing and disposed parallel to the direction of reciprocal movement of the plunger assembly. The solenoid assembly in this form may further comprise a plunger supporting rod connected to the tip of a plunger part of the plunger assembly and extending through the core member to a supporting linear bearing located in the housing externally to the core member.

Preferably, the coils can be wound with round wire, though square or rectangular wire is preferable as it is considered to reduce ohmic resistance.

In another form of embodiments, the present invention provides a solenoid assembly suitable for converting between electrical energy and mechanical movement, said solenoid assembly comprising:

a housing containing a core member and a coil assembly including at least one coil;

a plunger assembly adapted for reciprocal movement within said housing between a first position and a second position; and

a driver circuit for energizing said coil assembly characterised by a control means to adapt the driver circuit for energising said coil assembly with at least one initial pulse of current and a predetermined number, of subsequent pulses of current to cause said plunger assembly to move at least between said first and second positions.

Alternatively, embodiments may provide a solenoid assembly suitable for converting between electrical energy and mechanical movement, said solenoid assembly Comprising:

a housing containing a core member and a coil assembly including at least one coil;

a plunger assembly adapted for reciprocal movement within said housing between a first position and a second position; and

a driver circuit for energizing said coil assembly to produce the reciprocal movement of the plunger assembly by energizing the at least one coil with at least one initial pulse of current and a predetermined number of subsequent pulses of current such that the at least one coil produces an attracting magnetic field in the core member of the solenoid assembly relative to the plunger assembly for moving the plunger assembly from the first position to the second position followed by a repelling or at least a net neutral magnetic field for moving the plunger assembly from the second position to the first position.

In another form, embodiments of the present invention provide a method of energising a solenoid assembly suitable for converting between electrical energy and mechanical movement, the solenoid assembly comprising a housing containing a core member and a coil assembly including at least one coil; a plunger assembly adapted for reciprocal movement within said housing between a first position and a second position; and a driver circuit for energizing said coil assembly to cause said plunger assembly to move at least between said first and second positions, the method comprising the steps of:
a) supplying at least an initial current pulse from the driver circuit to the at least one coil to produce a magnetic field in the housing of the solenoid assembly that causes attraction between the core member and the plunger assembly to cause the plunger assembly to move between the first and second position. In preferred embodiments, the method may further comprise one or a combination of the steps of:
b) attenuating the current supplied from the driver circuit to the at least one coil for a relatively short period of time;
c) re-energising the at least one coil with a further current pulse from the driver circuit. The method may also be defined by wherein step b) further comprises maintaining a current residing in the at least one coil from the initial current pulse during the step of attenuating such that a magnetic field comparable to the field produced from the initial current pulse remains present for causing the plunger assembly to move between the first and second position.

The method may further comprise the steps of:
d) repeating steps a) to c) a first predetermined number of times for about 50% of the movement of the plunger assembly between the first and second position and;
e) once the plunger assembly has moved to the second position, repeating steps a) to c) a second predetermined number of times for moving the plunger assembly between the second and first position;

wherein the polarity of current pulses in steps a) to d) is opposite the polarity of current pulses in step e) to induce reciprocal movement of the plunger assembly between the first and second positions, respectively;

wherein the relatively short period of time in step b) is between about 2 ms and about 5 ms;

wherein the attenuating in step b) is caused by short circuiting the at least one coil; and

step c) is applied after step b) when current residing in the at least one coil has been attenuated by between about 5% to about 10%.

In further embodiments there is provided a plunger assembly for a solenoid assembly, said solenoid assembly adapted for converting between electrical energy and mechanical movement and comprising a housing containing a core member and a coil assembly including at least one coil, and, a driver circuit for energizing said coil assembly to cause said plunger assembly to move at least between a first position and a second position, the plunger assembly comprising:

a first material portion comprising permanent magnetic material and;

a second material portion comprising material of high relative magnetic permeability, wherein the material of the first material portion is located between material of the second material portion. The plunger assembly may further comprise a plunger supporting rod operatively connecting the plunger assembly with the housing of the solenoid assembly for aligning the reciprocal movement of the plunger assembly with a longitudinal axis of the housing. The plunger assembly may further comprise a shroud of thin metallic plating around the plunger portions and the second material portion comprises two parts that are each placed at each respective end of the first material portion.

The plunger assembly preferably may be defined wherein:

the permanent magnetic material of the first portion comprises a strong magnet; and

the material of the second portion comprises a magnetic permeability, p, of between about 4,500 and about 20,000. The permanent magnetic material of the first portion preferably comprises NdFeB; and, the material of the second portion comprises FeCo; and, the shroud comprises steel shim.

In other embodiments there is provided a solenoid assembly suitable for converting between electrical energy and mechanical movement, said solenoid assembly comprising;

a housing containing a core member and a coil assembly including at least one coil;

a plunger assembly adapted for reciprocal movement within said housing between a first position and a second position operatively connected to a scotch yoke for converting reciprocating linear motion of the plunger assembly into rotational motion of a crankshaft and

a driver circuit for energizing said coil assembly to cause said plunger assembly to move at least between said first and second positions.

The operative connection of the plunger assembly to a scotch yoke provides rotational motion of the crankshaft by way of the reciprocating plunger assembly being directly coupled to a sliding yoke with a slot that engages a pin on the rotating crankshaft. Preferably, the plunger assembly comprises at least two plungers disposed at each end of the scotch yoke and the driver circuit is adapted to energise the coil assembly so as to align the magnetic polarity of both plungers. Preferably, the solenoid assembly comprises two plunger assemblies adapted for reciprocal movement within respective housings containing a core member and a coil assembly including at least one coil, the plunger assemblies perpendicularly disposed to each other and each plunger assembly comprising two plungers disposed at each end of a respective scotch yoke and the driver circuit is adapted to energise the respective coil assemblies to synchronise movement of the plunger assemblies driving their respective scotch yokes to combine in converting linear motion of the respective plunger assemblies to rotational motion of the crankshaft.

In one aspect of embodiments described herein the present invention may provide an electric solenoid assembly and a solenoid driven electric motor or machine that is adapted to convert linear or reciprocating motion of one or more parts associated with a solenoid assembly into rotary motion of the machine or vice versa.

The or each solenoid assembly may include one or more coils and a plunger assembly such as a piston or slug that is adapted to move or reciprocate relative to the coil(s). The motor or machine may make use of captured emf during its operation as a motor to enhance conversion efficiency of the machine.

In another aspect of embodiments, in some configurations, the rotary machine may be adapted to behave as a generator. In this latter configuration emf may be captured from self-inductance, mutual inductance and/or emf induced by movement of a magnetic plunger assembly relative to the coil(s). In this respect, it is to be noted that where the present specification and appended claims refer to converting between electrical energy and mechanical energy then reference to “converting between” is to be taken as either conversion from electrical energy to mechanical energy (or motion) or conversion from mechanical energy/motion to electrical energy.

In yet a further aspect of embodiments described herein and above, a plurality of solenoid assemblies may operate in opposing pairs not unlike an internal combustion (IC) engine that is arranged in a “boxer” configuration. In this respect, plunger assemblies associated with the solenoid assemblies may be connected to a crankshaft via connecting rods in a manner that is also similar to an IC engine. Preferably, low friction bearings or bushes are used for the big and small ends of the connecting rods.

In an alternate and preferred embodiment plunger assemblies associated with the solenoid assemblies may be connected to a scotch yoke for converting reciprocating linear motion of the plunger assembly into rotational motion of a crankshaft by way of the reciprocating plunger assemblies being directly coupled to a sliding yoke with a slot that engages a pin on the rotating crankshaft. Furthermore, in a preferred embodiment a double scotch yoke configuration may be employed to convert reciprocating linear motion of the plunger assemblies into rotational motion of a crankshaft.

The or each solenoid assembly preferably includes one coil but may include up to at least three coils or stator windings. In One form of embodiments, for example as noted above, use is made of a scotch yoke arrangement as well as a horizontally opposed twin embodiment which, uses only one coil. The coils or stator windings may be connectable in series or parallel configurations, such that one or more coils or windings may be energized individually or collectively via a driver circuit as required. The driver circuit may be triggered via a crankshaft position detector that is responsive to angular position of the crankshaft of a motor. In one form the driver circuit may be triggered via a shaft encoder having at least 64 cycles per revolution of the crankshaft.

The or each magnetic plunger assembly may include at least three parts or sections. At least one part or section of the plunger assembly may include a relatively powerful permanent magnet. Preferably the or each permanent magnet includes a high grade (N42 or higher grade is preferred) rare earth magnet such as Neodymium (NdFeB) N52 grade magnet. For example, a 750 watt motor may require a high grade NdFeB magnet and a magnetic field that is about 1.2 T (tesla) or about 12,000 Gauss in strength.

The driver circuit may be adapted to energize one or more coils during an instroke of the magnetic plunger assembly to facilitate or assist natural attraction between the magnetic plunger assembly and a core member of the solenoid during the instroke. During an outstroke of the magnetic plunger assembly, the driving circuit may be adapted to energize one or more coils of one or more solenoid assemblies to at least cancel or neutralize the natural attraction between the magnetic plunger assembly and the respective core member of the or each solenoid assembly. Furthermore, the driving circuit may be adapted to energise one or more coils to repel the plunger assembly. This may assist outstroke travel of the magnetic plunger assembly. Outstroke travel of the magnetic plunger assembly may be further assisted by angular momentum of an associated flywheel. It is to be noted in other embodiments that there is no need for a flywheel. For example, in a preferred embodiment, which utilises a scotch yoke arrangement there is no need for a flywheel.

According to one aspect of embodiments of the present invention there is provided a solenoid assembly suitable for converting between electrical energy and mechanical movement (or vice versa), for example, in powering an electric motor, said solenoid assembly comprising: a housing containing a core member and a coil assembly including at least one coil; a plunger assembly adapted for reciprocal movement within said housing between a first position and a second position; and a driver circuit for energizing said coil assembly to cause said plunger assembly to move at least between said first and second positions.

In a preferred embodiment, the coil assembly includes at least one coil adapted to be energized via the driver circuit. In other embodiments, the coil assembly may include a plurality of coils, for example, at least three coils with each coil being adapted to be energized separately or collectively via the driver circuit. Each coil may include plural turns of copper magnet wire in plural layers.

The plunger assembly may include at least three plunger parts and at least one of the plunger parts may include a permanent magnet. A magnetic field associated with the permanent magnet may be oriented along an axis of movement of the plunger assembly. The permanent magnet may comprise a rare earth magnet such as a Neodymium (NdFeB) magnet.

The driver circuit may be adapted to generate a plurality of current pulses. The current pulses may include instroke and outstroke current, pulses. Each instroke current pulse may be applied to each coil in the coil assembly during movement of the plunger assembly between the first and said second positions. Each instroke current pulse may reach peak current within approximately 5-50% of its duration and may decay to zero current before the plunger assembly reaches the second position. Otherwise, if there is energy still residing in the coil the electronic driver may capture the residual energy into a capacitor and re-use the energy for the next pulse in sequence, each instroke current pulse may peak at a predetermined current, which may depend upon the physical size of the apparatus utilising the plunger assembly, eg a motor. In some embodiments each instroke current pulse has been observed to peak at approximately 3 to 9 amperes. However, this may be dependent upon coil size, the drive voltage and motor output required.

Each outstroke current pulse may be applied to at least one coil in the coil assembly during movement of the plunger assembly between the second and said first positions. Each outstroke current pulse may reach peak current within approximately 5 to 50% of its duration. Whilst there may still be energy in the coil(s) at BDC for a motor operation the electronic driver may capture the residual energy into a capacitor and re-use the energy for the next pulse in sequence. The outstroke current pulse may, in certain embodiments, decay to zero current before the plunger assembly reaches the first or outer position. Otherwise, each outstroke current pulse may peak at a predetermined current value. In some embodiments each outstroke current pulse has been observed to peak at between about 5-9 amperes. The driver circuit may be implemented via digital control including PWM.

According to a further aspect of embodiments of the present invention there is provided an electric motor incorporating at least one or at least one pair of solenoid assemblies, each solenoid assembly being as described above. The electric motor may include at least one pair of solenoid assemblies arranged in an appropriate configuration, such as for example, a boxer configuration, a scotch yoke configuration or a double yoke configuration. The electric motor may be substantially dry running. The electric motor may include an electric generator driven via the motor for powering the driver circuit.

According to a still further aspect of embodiments of the present invention there is provided a method of operating a solenoid assembly suitable for powering an electric motor, said solenoid assembly comprising a stator including at least one or a plurality of coils and a reciprocating plunger assembly, said method including: energizing said coil(s) to produce a magnetic field in said stator that varies in magnitude and polarity to cause successive attraction and repulsion between at least a part of said stator and said plunger assembly to produce said reciprocating movement; said energizing including generating instroke current pulses to the coil or to a first subset of said plurality of coils during an instroke of said plunger assembly; and said energizing including generating outstroke current pulses to the coil or a second subset of said plurality of coils during an outstroke of said plunger assembly; wherein for a single coil the coil interacts with said plunger assembly upon generating instroke current pulses to produce a first magnetic circuit and interacts with said plunger assembly upon generating outstroke current pulses to produce a second magnetic circuit different to said first magnetic circuit; and for a plurality of coils said first subset of coils interacts with said plunger assembly to produce a first magnetic circuit and said second subset of coils interacts with said plunger assembly to produce a second magnetic circuit different to said first magnetic circuit.

According to yet another aspect of embodiments of the present invention there is provided a method of converting between electrical energy and mechanical movement in a system including a housing comprised of a coil assembly and a core, the system further including a plunger assembly adapted for movement through the housing between a first position and a second position, the method comprising the steps of:

physically assisting the motion of at least a magnetised portion of the plunger assembly as a function of location between the first and second positions.

The step of physically assisting may include one or a combination of:

pulsing at least one current applied to the coil assembly at predetermined intervals;

providing a gradient of magnetic permeability to the material of one or a combination of the housing and the plunger assembly, and; providing stored energy from an energy storage means operatively associated with the system.

The plunger assembly movement through the housing is preferably through the centre of the coil(s).

The energy storage means may include a flywheel in a conventional or boxer configuration for a motor assembly or may include shaft counter weights in, for example, a scotch yoke configuration.

In the above method, the predetermined intervals may correspond to an instroke and an outstroke of the movement of the magnetised portion of the plunger through the housing.

In the above method, the step of physically assisting may include accelerating, where the accelerating includes one of positive acceleration or negative acceleration.

Still another aspect of embodiments of the invention provides apparatus for converting between electrical energy and mechanical movement including:

a housing comprised of a coil assembly and a core;

a plunger assembly adapted for movement through the housing between a first position and a second position, and;

motion assisting means for physically assisting the motion of at least a magnetised portion of the plunger assembly as a function of location between the first and second positions.

The motion assisting means may include one or a combination of:

a driver circuit adapted for pulsing at least one current applied to the coil assembly at predetermined intervals;

a gradient of magnetic permeability to the material of one or a combination of the housing and the plunger assembly;

an energy storage means operatively connected to the plunger assembly adapted for storing angular momentum. In one embodiment, the energy storage means comprises a flywheel.

The predetermined intervals may correspond to an instroke and an outstroke of the movement of the magnetised portion of the plunger through the housing.

The motion assisting means is preferably adapted for accelerating the magnetised portion of the plunger assembly, where the accelerating includes one of positive acceleration or negative acceleration.

There may also be provided in embodiments of, the invention an energy storage means adapted for operative connection to an electric motor as disclosed herein for storing angular momentum of an associated crankshaft wherein the energy storage means is adapted to apply stored energy to the solenoid assembly as disclosed herein.

In essence, many aspects of the present invention stem from the realisation that the resultant magnetic field induced and maintained by the arrangement and coil control causes the plunger to move in the appropriate directions whether power is being applied to it or not. This is one of the main reasons that such high energy efficiency is achieved in preferred embodiments. The coil control method also preferably should be accompanied by a plunger that is capable of having a magnetic field induced in it so that the magnetic field can vary in strength relative to the plunger position requirements.

Other aspects and preferred forms are disclosed in the specification and/or defined in the appended claims, forming a part of the description of the invention.

Further scope of applicability of embodiments of the present invention will become apparent from the detailed description given hereinafter. However, it should be understood that the detailed description and specific examples, while indicating preferred embodiments of the invention, are given by way of illustration only, since various Changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present invention may be better understood by those skilled in the relevant art by reference to the following description of embodiments taken in conjunction with the accompanying drawings, which are given by way of illustration only, and thus are not limitative of the disclosure herein, and in which:

FIG. 1 illustrates shows a perspective view of a solenoid driven motor according to one embodiment of the present invention;

FIG. 2 shows a cross-sectional view of the solenoid driven motor of FIG. 1;

FIG. 3 shows an example of a driver circuit and associated electronics in accordance with a preferred embodiment that is suitable for use with the solenoid driven motor of FIG. 1;

FIG. 4 shows timing diagrams illustrating the general behaviour of current within coils of a preferred solenoid arrangement associated with one embodiment of the driver circuit of FIG. 3;

FIG. 5 shows a series of timing diagrams similar to FIG. 4 but in more detail associated with another embodiment of the driver circuit of FIG. 3;

FIG. 6 is a perspective cut away view of a solenoid driven motor according to another embodiment of the present invention;

FIG. 7 is a partial perspective cut away view of the solenoid driven motor of FIG. 6;

FIG. 8 is a partial side cross sectional view of the solenoid driven motor of FIG. 6;

FIG. 9 is a further partial side cross sectional view of the solenoid driven motor of FIG. 6 showing the details of a linear bearing arrangement in accordance with an embodiment of the present invention;

FIG. 10 displays an oscilloscope scope trace of the current within a single coil in accordance with a preferred embodiment of the present invention;

FIG. 11 shows side, front and rear end views of a plunger assembly in accordance with a preferred embodiment of the present invention;

FIGS. 12a and 12b are elevational views of plunger assemblies adapted for a scotch yoke arrangement in accordance with preferred embodiments of the present invention;

FIG. 13 is a perspective cut away view of a solenoid driven motor in accordance with another preferred embodiment of the present invention including two scotch yoke arrangements utilising the scotch yoke arrangement shown in FIG. 12b.

FIGS. 14 and 15 show cross sectional plan views of the arrangement of the solenoid driven motor as illustrated in FIG. 13 indicating progressive stages of the cycle of motion produced by a plunger assembly deploying the preferred scotch yoke arrangement.

### DETAILED DESCRIPTION

The exemplary electric motors and associated rotary machines described hereinafter are preferred embodiments of the invention. Accordingly, it is to be noted that in some alternate configurations one or a combination of the electric motor and the rotary machine may be adapted to behave as a generator. In this respect the system and apparatus of the present invention may be embodied in a 750 W electric motor being an exemplary form of the invention, however, it is to be noted that the inventive features of the present system may be scaled to larger systems or be scaled down to lower output systems.

### Horizontally Opposed Twin (HOT) Embodiments

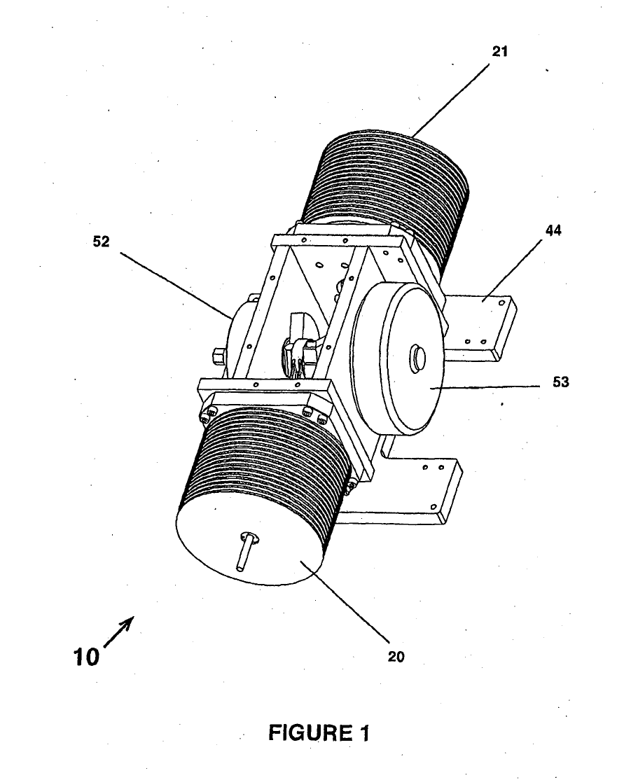

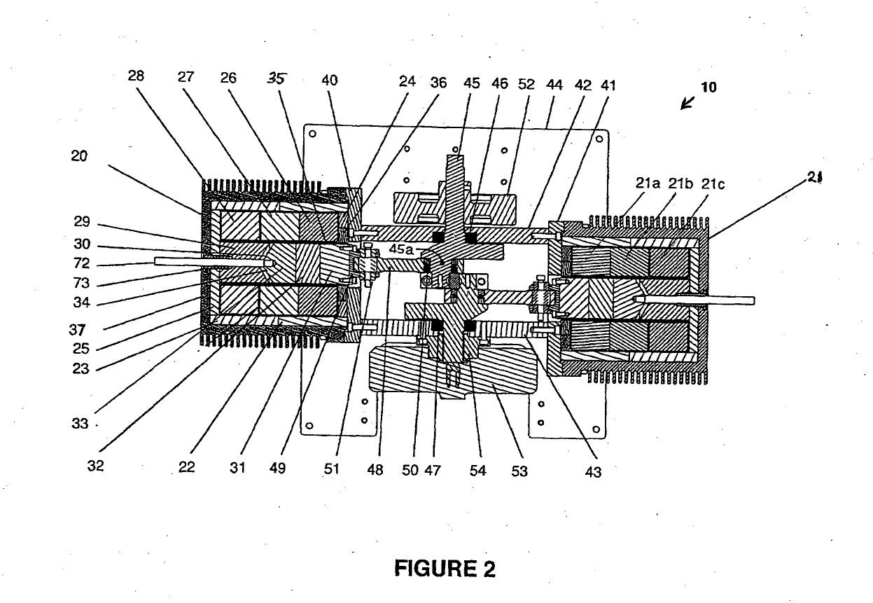

Referring to FIGS. 1 and 2, solenoid motor 10 includes a pair of solenoid assemblies 20, 21 arranged in an opposing configuration not unlike an IC engine that operates in a “boxer” configuration. Solenoid assembly 20 will be described below in detail. It is to be understood that solenoid assembly 21 may be constructed in similar fashion to solenoid assembly 20, although it may be offset laterally relative to an axial extent to facilitate engagement with a common crankshaft.

Solenoid assembly 20 includes a solenoid housing comprising inner and outer solenoid sleeves 22, 23 and inner and outer solenoid end plates 24, 25. Solenoid sleeves 22, 23 each comprises a material with relatively very high magnetic permeability (μ=about 20,000) such as an alloy comprising about 49% iron, about 49% cobalt and about 2% vanadium which has been properly treated to enhance its magnetic properties, such as being annealed. Inner and outer end plates 24, 25 each comprises a material with relatively very high magnetic permeability (μ=about 14,000) such as an alloy comprising about 49% iron, about 49% cobalt and about 2% vanadium. One reason for the very high magnetic permeability of sleeves 22, 23 is to better capture and concentrate a magnetic field.

Moreover improved efficiency of an associated magnetic circuit may be obtained by providing a “gradient” of permeabilities wherein a high permeability material is preferred on the outside of the solenoid assembly and a lower permeability material relative to the permeability of the solenoid housing is preferred on the inside of the solenoid assembly.

A relatively lower magnetic permeability (μ=about 14,000) compared to that of sleeves 22, 23 may be acceptable for end plates 24, 25. This may be due in part to the associated manufacturing process which may cause a reduction of permeability. However, it may assist in providing the above mentioned “gradient” of permeability along the path of the magnetic circuit starting at the core 29, then passing across end plates 24, 25 and then passing down sleeves 22, 23.

As shown in FIG. 2, solenoid assembly 20 includes a coil assembly comprising inner, middle and outer coils 26, 27, 28 respectively. Each coil 26, 27,28 preferably comprises approximately 638 turns of 2.1 mm diameter copper magnet wire in 22 layers. The number of turns and the size or gauge of wire may vary depending on the motor and its capacity as would be understood by the person skilled in the art. Each coil 26, 27, 28 is connectable to a driver circuit such that it may be energized individually, or in combination with another coil. The coil assembly preferably is located laterally relative to and substantially adjacent a stroke zone of a reciprocating plunger assembly as described below. In the embodiment illustrated in FIGS. 1 and 2 the coil assembly is located in this manner coaxially with the stroke zone.

Solenoid assembly 20 includes core member 29 adjacent end plate 25. Core member 29 comprises a material with relatively high magnetic permeability (e.g. μ0.1=about 4,500) and saturation (e.g. about 2 Tesla) such as an alloy comprising about 50% iron and about 50% cobalt. The permeability of core member 29 is relatively lower compared to parts 22-24 of the solenoid housing. The inner face 30 of core member 29 includes a concave surface that is substantially conical in shape. The conical surface may be formed at an angle of between approximately 30 to 60 degrees.

Solenoid assembly 20 includes a movable plunger assembly comprising inner, middle and outer parts 31, 32, 33 respectively. Inner and outer parts 31 and 33 of the plunger assembly each comprises a material with relatively high magnetic permeability (e.g. μ=about 4,500) such as an alloy comprising about 50% iron and about 50% cobalt. Outer part 33 of the plunger assembly includes a convex and substantially conical tip 34 adapted to nest in the concave face 30 of core member 29. There may be a gap between outer part 33 of the plunger assembly and face 30 of core member 29. In one form the gap between part 33 and core member 29 at TDC may be approximately 1 mm.

Middle part 32 of the plunger assembly comprises a permanent magnet such as high grade rare earth permanent magnet. One example of a permanent magnet is a Neodymium (NdFeB) N52 grade magnet with a magnetic field strength that is about 1.2 T. Under Finite Element Analysis modelling of the system it has been indicated that excessive permeability for inner end plate 24 preferably should be avoided as it may give rise to a short in the magnetic circuit on the outstroke of the plunger assembly. However, in practical embodiments this problem with excessive permeability has not eventuated. Excessive permeability for core member 29 and parts 31 and 33 of the plunger assembly preferably should be avoided as this may make the plunger assembly too difficult to dislodge from top dead centre (TDC) when starting the outstroke towards bottom dead centre (BDC).

The plunger assembly is adapted for reciprocating movement relative to the solenoid housing between top dead centre (TDC) and bottom dead centre (BDC). Reciprocal movement is achieved in part by energizing one or more coils 26, 27, 28 such that the coil(s) produce an attracting magnetic field in core member 29 of the solenoid assembly relative to the plunger assembly followed by a repelling or at least a net neutral magnetic field.

The magnetic field associated with the permanent magnet of middle part 32 of the plunger assembly may be such that it is oriented along the axis of movement of the plunger assembly. The parts 31, 32, 33 of the plunger assembly may be joined or united by means of an adhesive such as epoxy resin.

To reduce friction a tubular sleeve 35 formed from a material having a low coefficient of friction, such as Teflon or PTFE, is interposed between the stationary coil assembly and the reciprocating plunger assembly. Sleeve 35 may include a plurality (e.g. six) of radially projecting longitudinal splines along its inner surface to substantially reduce contact area between itself and the reciprocating plunger assembly. In one form the projecting splines may reduce the contact area by about 90%. In some embodiments tubular sleeve 35 may include metal or metal alloy splines such as bronze. In one particular embodiment for HOT motors, only a smooth thin tube of rigid non-magnetic material, preferably bronze, is utilised to support the coils(s) such that the plunger does not make contact with the coils. Other means for reducing friction are considered herein below.

Solenoid assembly 20 includes locating ring 36 interposed between end plate 24 and sleeve 35. Locating ring 36 is formed from a magnetically inert material such as aluminium such that it may effectively function as an air gap between end plate 24 and outer part 31 of the plunger assembly. In some embodiments locating ring 36 may be formed from a magnetically permeable material similar to the material used for end plate 24. In some embodiments locating ring 36 may be dispensed with. Instead end plate 24 may have an entry hole sized to match the outer diameter of tubular sleeve 35. This may increase the force generated during the in-stroke.

Solenoid assembly 20 includes an outer casing 37. Casing 37 is substantially cup-shaped to provide a close fit over parts 22, 23 and 25 of the solenoid housing. Outer casing 37 may include a plurality of radially extending fins around its circumference to facilitate or at least enhance dissipation of heat from the solenoid assembly. Casing 37 is formed from a magnetically inert material such as aluminium.

Solenoid assemblies 20, 21 are attached to a crankcase housing comprising end walls 40-44. A crankshaft assembly 45 is journalled for rotation in end walls 42, 43 via annular ceramic bearings 46, 47.

The plunger assembly (31, 32, 33) associated with solenoid assembly 20 is connected to a crankpin 45a of crankshaft assembly 45 via connecting rod (conrod) 48 and interface clevis 49. Interface clevis 49 is attached to a face of inner part 31 via high tensile bolts. The big end of conrod 48 is attached to crankpin 45a via an annular ceramic bearing 50. The small end of conrod 48 is connected to interface clevis 49 via gudgeon pin 51.

Crankshaft assembly 45 is formed in two parts to facilitate one piece connecting rods and bearings. Crankshaft assembly 45 is formed from a magnetically inert material such as austenitic stainless steel.

A flywheel 52 is attached to one end of crankshaft assembly 45 for storing angular momentum associated with the solenoid motor. Flywheel 52 is formed from a magnetically inert material such as aluminium or other non-magnetic or marginally magnetic material.

An electric generator 53 can be attached via adapter 54 to another end of crankshaft assembly 45 for generating a supply of electric power. The electric power may be used to charge a battery and/or for powering the associated driver circuit and crankshaft position detector and/or any other device whether or not it is associated with the solenoid driven motor. Furthermore, electrical power may be provided in this manner to any device. In one form the motor provided in this embodiment may be a hybrid of a brushless DC motor and an AC induction motor. This is so given that this motor is in fact a brushless DC motor using permanent magnets but also an AC induction motor given that the power supply along with other electronics, eg coil control, may be adapted to become AC driven and that a magnetic field is being induced within the plunger parts either side of the permanent magnet portion.

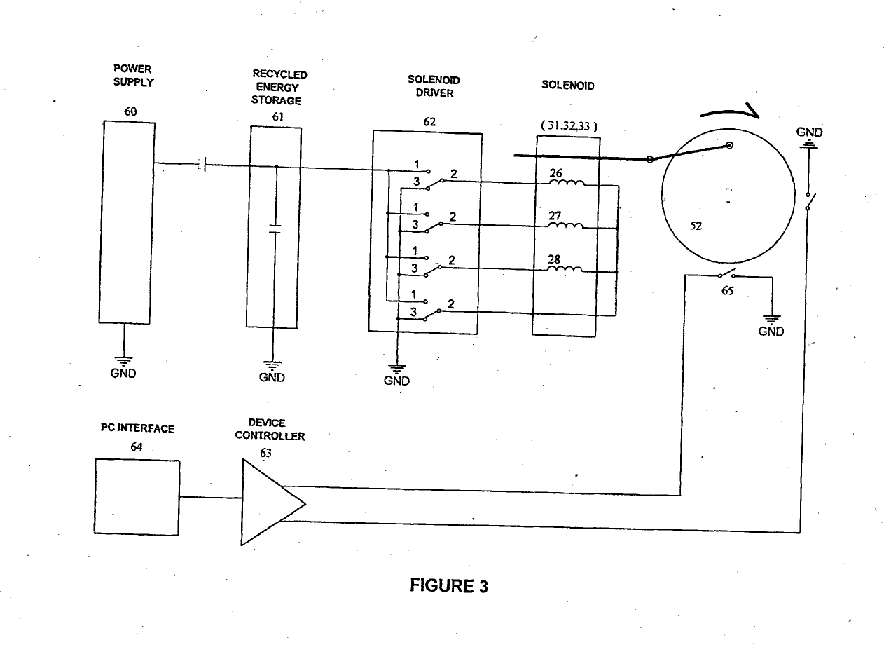

FIG. 3 shows a block diagram of a driver circuit for driving coils 26-28 associated with solenoid assembly 20. A similar driving circuit (not shown) may be adapted for driving coils 21a-c associated with solenoid assembly 21. The driver circuit includes a power supply 60, a recycled energy storage module 61, a solenoid driver 62, a device controller 63 and a user interface 64. Driver 62, controller 63 and user interface 64 may be implemented via digital or analogue control means.

Preferably elements 62-64 are implemented via digital control means, for example driver 62 and controller 63 may include digital control means such as pulse width modulation (PWM) implemented in hardware and/or software.

Power supply 60 is adapted for supplying electrical power to one or more parts 61-64 of the solenoid assembly and/or electric motor. Power supply 60 may include a storage battery. The storage battery may be charged via an electric generator such as generator 53 associated with the solenoid motor and/or an external power supply. In one preferred embodiment, the storage battery is replaced by an on-board power supply dedicated for running the electronic components of the motor. Storage module 61 may include any suitable temporary energy storage device such as a capacitor.

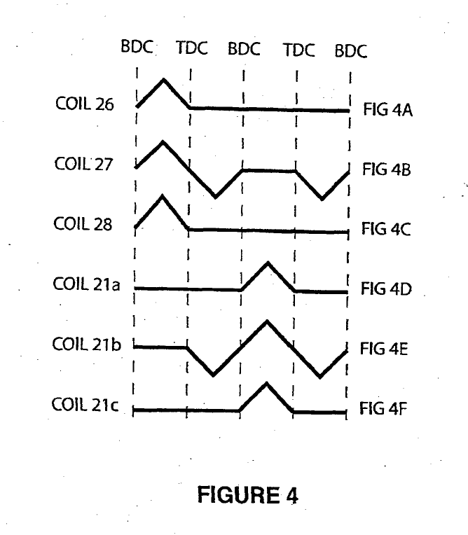

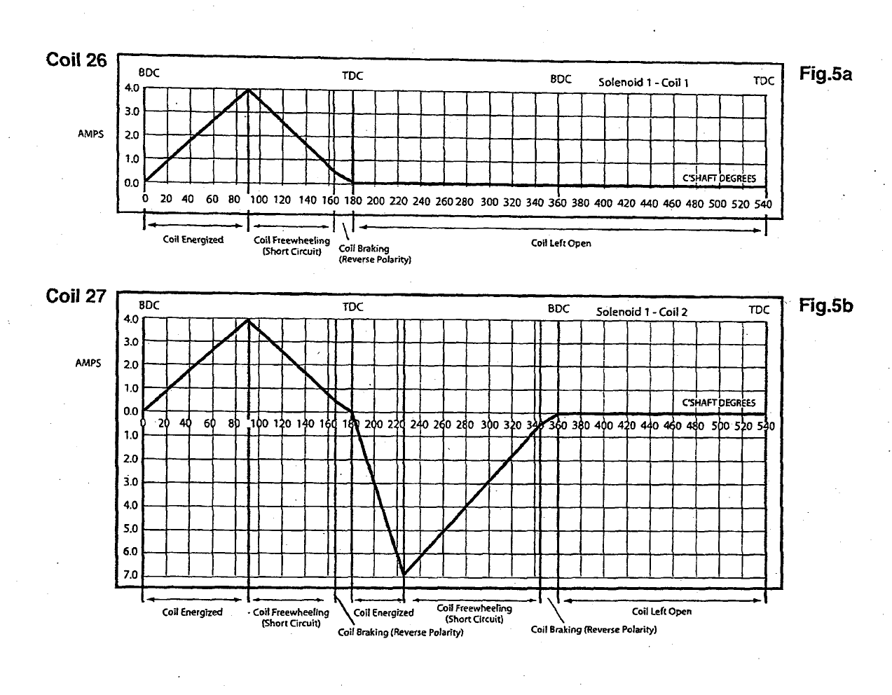

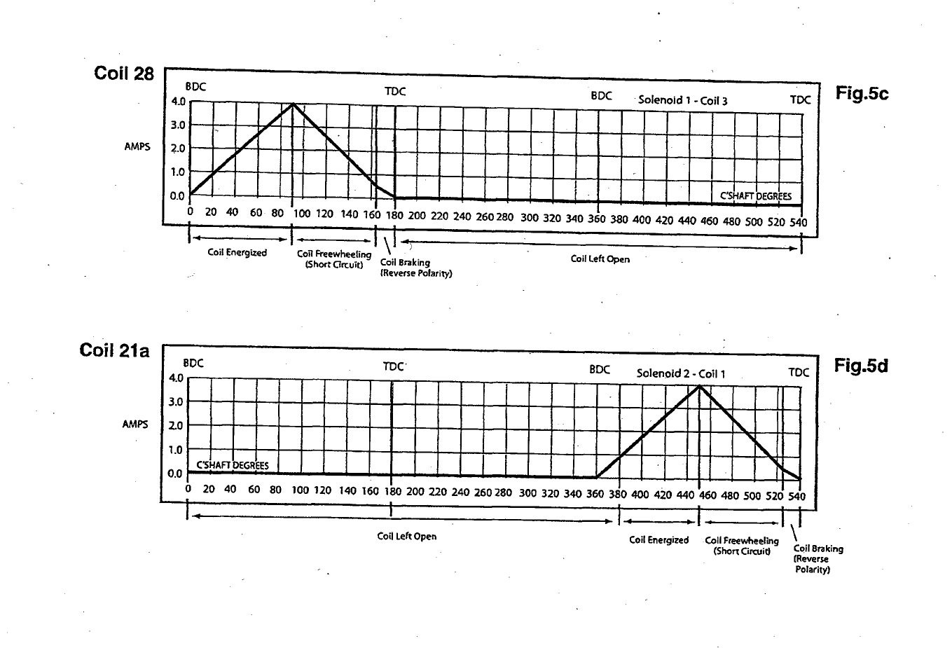

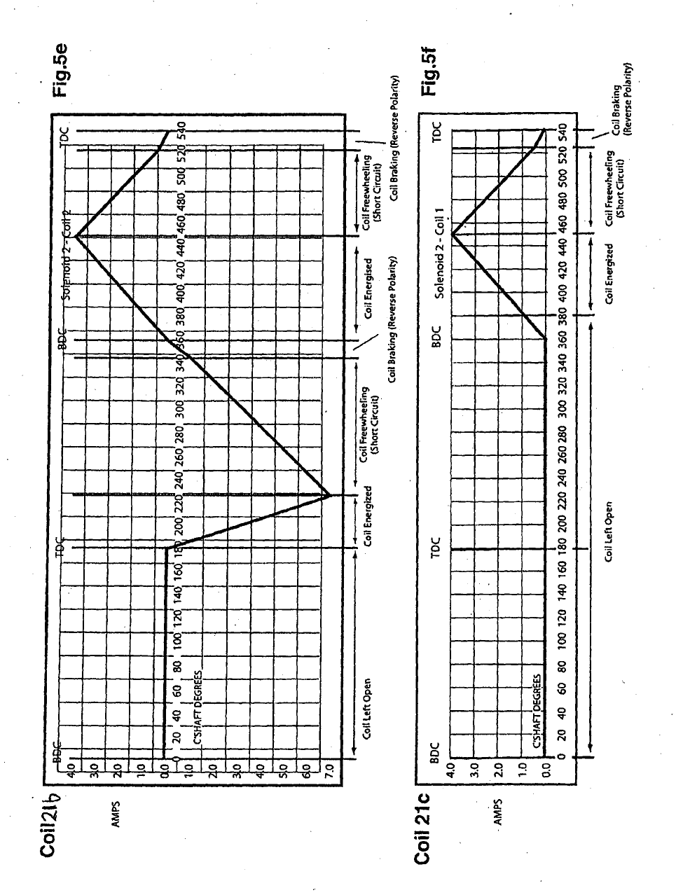

Solenoid driver 62 and solenoid controller 63 are adapted to supply inner, middle and outer coils 26-28 with current pulses, the current pulses being as generally shown in FIG. 4. For example, during an instroke of the plunger assembly, coils 26-28 may be supplied with respective symmetrical or asymmetrical pulses of current such as saw-tooth pulses as shown in FIG. 4 and also as shown in more detail in FIG. 5. The current pulses may include in-stroke and outstroke current pulses. The current pulses produce a magnetic field in the core of the solenoid assembly that varies in magnitude and polarity to cause successive attraction and/or repulsion between core member 29 and the plunger assembly. It is to be noted that the duty cycle is relatively substantially low, for example, around 55% as compared to prior art electric motors, which generally have duty cycles that may be marginally under 100%.

FIG. 4 shows current pulses produced by one embodiment of the driver circuit of FIG. 3. Referring to FIG. 4 the instroke current pulses commence at BDC. Assuming an instroke approximately 50 ms in duration each instroke current pulse may be approximately 43 ms in duration or about 86% of the duration of the instroke. The peak of the instroke pulse may be about 4 amperes and may be reached after about 11 ms to about 23 ms or approximately 26% to about 50% of the duration of the instroke. The instroke pulse may then fade or decay to about 0 amperes. Fade out of the instroke pulse may be assisted by counter emf induced in the coils and movement of the magnetic plunger assembly through the coils. The driver circuit may apply a drive voltage to the coils only until peak current level has been reached.

Once the instroke current decays to about 0 amperes, induced emf generated by the moving permanent magnet(s) may be captured. The captured energy may be directed to storage module 61 via driver 62 and controller 63. Storage module 61 may include a capacitor that may be sized to hold a correct level of voltage for the outstroke that immediately follows the instroke. The emf is opposite in polarity to the drive voltage applied for the instroke and may therefore be the correct polarity for the next outstroke.

As may be seen in FIG. 4 when coils 26-28 associated with solenoid assembly 20 are energized during an instroke, the three coils 21a-c associated with solenoid assembly 21 are not energized. In a subsequent instroke when coils 21a-c associated with solenoid assembly 21 are energized, coils 26-28 associated with solenoid assembly 20 are not energized. This may allow the coils of solenoid assemblies 20, 21 to rest during alternate instroke cycles to enhance cooling and reliability of the solenoid motor. In some embodiments both solenoids may be energized during the instroke.

During an outstroke of the plunger assembly middle coil 27 associated with solenoid assembly 20 is energized together with the middle coil 21b associated with solenoid assembly 21. The middle coils of solenoid assembly 20, 21 are supplied with respective asymmetric saw tooth pulses of current as shown in FIGS. 4B and 4E.

The outstroke current pulses commence at TDC. Assuming an outstroke approximately 50 ms in duration each outstroke current pulse may be approximately 5 ms to about 10 ms or about 11% to about 22% of the duration of the outstroke. The peak of the outstroke pulse may be about 7 amperes and may be reached within about 5 ms to about 10 ms or about 11% to about 22% of the duration of the outstroke. The current may then decay to about 0 amperes over the next period of time being about 42 ms. In approximately the last 3 ms induced emf, back emf and emf that is mutually induced in coils 26, 28, 21a, 21c is captured in storage module 61 for use in the next instroke. The captured emf is opposite in polarity to that used for the outstroke and is therefore of a correct polarity for the next instroke. The outstroke pulse may require a higher drive voltage than the instroke pulse due to the faster rise time required. However, in practice generally this has not been the case. The additional drive voltage may be captured from the preceding instroke.

Theoretically, a higher voltage may be required to reach peak current (7 A) during the outstroke compared to the instroke (4 A) because the current is higher. However, in practice, almost the opposite occurs, in so much as when energising all coils there is greater resistance and a higher voltage is required. Fade out of the pulses may be assisted by counter emf induced in the coils and movement of the magnetic plunger assembly through the coils. Residual emf may be captured in coils that are not being energized may be diverted via driver 62 and controller 63 to storage device 61, such as a capacitor, for use in driving the coils during other cycles. The captured energy is due in part to the braking phase. The captured energy may be stored in the capacitor. Reversal of polarity across a coil drives the energy into the capacitor just as the plunger assembly is coming to a stop at TDC or BDC before reversing direction.

FIG. 5 shows in more detail than FIG. 4 current pulses produced by another embodiment of the driver circuit of FIG. 3 throughout the cycle of the crankshaft. Referring to FIG. 5 the instroke current pulses commence at BDC. Each instroke current pulse includes a coil energizing phase, a coil freewheeling phase and a coil breaking phase. Assuming an instroke approximately 50 ms in duration each instroke current pulse may be approximately 11 ms to about 23 ms in duration or about 26% to about 50% of the duration of the instroke. The peak of the instroke pulse may be about 4 amperes and may be reached after about 11 ms to about 23 ms or approximately 26% to about 50% of the duration of the instroke. The instroke pulse may then fade or decay to about 0 amperes during the coil freewheeling phase (short circuit) followed by the coil braking phase (reverse polarity).

Once the instroke current decays to about 0 amperes, induced emf generated by the moving permanent magnet(s) may be captured in coils that are not being energized for subsequent use in driving the coils during other cycles. The captured energy may be directed to storage module 61 via driver 62 and controller 63. Storage module 61 may include a capacitor that may be sized to hold a correct level of voltage for the outstroke that immediately follows the instroke. The emf is opposite in polarity to the drive voltage applied for the instroke and may therefore be the correct polarity for the next outstroke.

As may be seen in FIG. 5 when coils 26-28 associated with solenoid assembly 20 are energized during an instroke, the three coils 21A-C associated with solenoid assembly 21 are not energized. In a subsequent instroke when coils 21A-C associated with solenoid assembly 21 are energized, coils 26-28 associated with solenoid assembly 20 are not energized. This may allow the coils of solenoid assemblies 20, 21 to rest during alternate instroke cycles to enhance cooling and reliability of the solenoid motor. In some embodiments both solenoids may be energized during the instroke. For embodiments where the motor may run on just a single coil the solenoids are energised for both instroke and outstroke.

During an outstroke of the plunger assembly middle coil 27 associated with solenoid assembly 20 is energized together with the middle coil 21B associated with solenoid assembly 21. The middle coils of solenoid assembly 20, 21 are supplied with respective asymmetric saw tooth pulses of current as shown in FIGS. 5B and 5E.

The outstroke current pulses commence at TDC. Each outstroke includes a coil energizing phase and a coil freewheeling phase and a coil braking phase. Assuming an outstroke approximately 50 ms in duration each outstroke current pulse may be approximately 5 ms to about 10 ms or about 11% to about 22% of the duration of the outstroke. The peak of the outstroke pulse may be about 7 amperes and may be reached within about 5 ms to 10 ms or about 11% to about 22% of the duration of the outstroke pulse. The current may then decay to about 0 amperes over the next period of time being about 38 ms during the coil freewheeling phase (short circuit) and the coil braking phase (reverse polarity). In about the last 4 ms induced emf, back emf and emf that is mutually induced in coils 26, 28, 21a, 21c is captured in storage module 61 for use in the next instroke. The captured emf is opposite in polarity to that used for the outstroke and is therefore of a correct polarity for the next instroke. The outstroke pulse may require a higher drive voltage than the instroke pulse due to the faster rise time required. The additional drive voltage may be captured from the preceding instroke.

In practice, when energising all coils there is greater resistance and a higher voltage is required. Fade out of the pulses may be assisted by counter emf induced in the coils and movement of the magnetic plunger assembly through the coils. Residual emf captured in coils that are not being energized may be diverted via driver 62 and controller 63 to storage device 61 for use in driving the coils during other cycles.

In one embodiment, timing for the driver 62 and controller 63 is provided via a crankshaft position detector 65 such as a rotary encoder or proximity sensor that detects presence of a timing plate (not shown) attached to flywheel 52 to facilitate synchronizing the instroke and outstroke current pulses with TDC and BDC cycles of the plunger assembly. In a preferred embodiment of the crankshaft position detector 65 comprises a rotary encoder having at least 64 cycles per revolution of the crankshaft. The rotary encoder may be used to control pulses to each coil relative to position of the crankshaft.

User interface 64 may include a digital device such as a suitably programmed personal computer. User interface 64 may be used to modify peak current levels for instroke and outstroke pulses as well as duration of the pulses and timing of the start of the pulses relative to TDC, BDC and/or fade out of a previous pulse or pulses. User interface 64 may be used to optimize operating conditions of the solenoid motor relative to expected and/or actual speed and/or load applied to crankshaft assembly 45.

In operation during an instroke of the plunger assembly the permanent magnet (PM) part 32 is magnetically saturated (μ=about 1), so not much magnetic field force is added when coils 26-28 are energized. However magnetic field and consequent force is added to the conical tip 34 of the plunger assembly, the bottom section of the plunger assembly and the concave face 30 of core member. This may improve magnetic circuit integrity and performance. The material used for plunger parts 31, 33 has a saturation point of about 2 T and this may vary with nominal motor output. The magnetic fields of the PM part 32 (about 1.2 T) and solenoid coils 26-28 combine and contribute a significant amount of magnetic force being applied to the plunger assembly (about 1.6 kN at the top of the instroke, again this may vary with nominal motor output). The plunger parts 31, 33 are constantly being magnetized to a degree because of their proximity to PM part 32. When the magnetic field is introduced into the magnetic circuit via coils 26-28, these parts are “topped up” in terms of their level of magnetic field strength and the force being applied by the field. When power to the coils is removed, the “top-up” portion of the magnetic field is also removed.

Increasing the force applied to the plunger assembly increases the angular momentum applied to flywheel 52. The momentum stored in flywheel 52 helps to overcome natural magnetic attraction between PM part 32 and core member 29 when the plunger assembly is at TDC and is commencing its travel towards BDC. When the plunger assembly reaches TDC, kinetic energy is transferred from the plunger assembly to flywheel 52 and magnetic fields are no longer present in plunger parts 31, 33.

During the commencement of an outstroke of the plunger assembly the natural magnetic attraction between the plunger assembly and core member 29 needs to be overcome to minimize loss of angular momentum when moving from the in-stroke to the out-stroke of the plunger assembly.

In essence angular momentum stored in flywheel 52 may act as a “lever” wherein energy being applied to crankshaft assembly 45 (and therefore the plunger assembly) may be supplied from flywheel 52. For example instead of requiring a direct linear applied force of about 1.6 kN to dislodge the plunger assembly from the core member 29, one may need only about 400N when taking into account the “lever action” of flywheel 52. Flywheel 52 should be sized and dimensioned relative to this requirement and the mass/inertia of the plunger assembly.

The degree of natural magnetic attraction to overcome during the outstroke is essentially determined by the force from PM part 32. As noted above, this force is substantially overcome by angular momentum stored in flywheel 52. The amount of force generated during the in-stroke may be varied by energizing coils 26-28 and then allowing them to “freewheel”, which may extend duration of the magnetic field in the coils while PM part 32 is moving closer to core member 29. The closer that the PM part 32 moves to core member 29, the more pronounced is the magnetic force on the plunger assembly due to the reducing air-gap, and the greater is the velocity of the plunger assembly.

When the above approach is used with a peak current of about 4 amperes, the peak velocity of the plunger assembly close to TDC is about 2.5 m/s after an in-stroke roughly about 45 ms in duration. Also in the preferred embodiment described above the in-stroke current pulse is only active for about half of the duration of the in-stroke. In theory, too high an in-stroke current should be avoided as this may give rise to an excessive amount of force in a relatively short period of time. The significance of this force is that too high a resultant reciprocating frequency may cause too much vibration on the PM which may then weaken the magnetic field of the PM. However, in practice with a preferred embodiment, it has not been the case that too much vibration has been produced on the permanent magnet and therefore the magnetic field of the PM has not been weakened.

Apart from embodiments using only a single coil, because a different magnetic circuit is active during outstroke travel of the plunger assembly away from TDC, the ° magnetic field in conical tip 34 of the plunger assembly is not as strong as it was when it was travelling towards TDC. After the plunger assembly has moved a small distance away from core member 29 the natural magnetic attraction drops off relatively rapidly. This is also due in part to the natural magnetism of the PM part 32 acting through the ferrous conical tip 34. If the material of conical tip 34 has too high a permeability, there may be too much magnetic attraction to overcome. This is one reason that a material having a lower permeability is used for plunger parts 31, 33 when compared to end plates 24, 25 and housing parts 22, 23.

The reason that a different magnetic circuit is active during the outstroke cycle when compared to the instroke cycle is due to use of middle coils 27, 21b only to repel the plunger assembly during the outstroke cycle, since magnetic coupling between PM part 32 and middle coil 27 is stronger at this stage of the cycle than magnetic coupling between PM part 32 and the core member 29. When the conical tip 34 of the plunger assembly sits at TDC, the PM part 32 is located with no more than about the top 45% of the PM part 32 inside middle coil 27. Since middle coil 27 is energized in a polarity opposite to the in-stroke this positioning places opposing poles of middle coil 27, and the magnetic field of PM part 32 very close to each other, resulting in a strongly repelling magnetic coupling. The magnetic circuit, although not as “clean” throughout the housing as during the in-stroke circuit, is sufficient to cause the plunger to move outwards and to sustain reciprocating action. This scenario applies for multiple coils but is not applicable for a single coil arrangement.

In one embodiment it may be preferable to have end plates 24, 25 present only during the in-stroke cycles and no end plates present during the out-stroke cycles as this would give a strong magnetic circuit through the core member 29 during the in-stroke and a much weaker circuit through the core member 29 during the out-stroke. Considering the energy transfer from the plunger assembly to flywheel 52 and back again every time the plunger assembly enters either TDC or BDC, the out-stroke only needs to be force-neutral as the inertia of flywheel 52 is sufficient to allow the solenoid motor to run very efficiently without applying much force during the out-stroke cycle.

Reducing permeability of end plates 24, 25 or introducing an air-gap into the magnetic circuit also assists in overcoming the natural magnetic attraction noted above. In some embodiments it may be possible to add a mechanism (not shown) to move end plate 25 (or end plate 24—although end plate 25 is preferable) outwardly from solenoid assembly by a few millimetres at the start of each outstroke as this may improve out-stroke magnetic circuit performance by introducing an extra air-gap into the magnetic circuit. Whilst this may be beneficial, it is not required for operation of the invention. Permeability of one or both plates 24, 25 may also be reduced during the out-stroke by introducing an AC magnetic field of 15 MHz or more for the duration of the outstroke, providing that the AC H-field is higher than any B-field in the plate from the coils 26-28 or PM part 32. Winding a special flat coil on top of each plate 24, 25 may achieve the desired result providing that an appropriate number of ampere turns is applied through the special coils. This may not be too difficult to achieve as the PM and coil fields are relatively weak inside plates 24, 25. Most of the magnetic force is between the plunger assembly and core member 29. The features recited in this paragraph should be considered as possible improvements only and not essential to the operation of the basic solenoid and motor.

Further improvements may include adjusting energizing of the various coils in a specific sequence to optimize magnetic coupling with the PM part 32 for the outstroke. This may be done by considering the position of PM part 32 when relative to middle and bottom coils 27, 26. Again, this aspect should not be considered essential but may deliver an improvement for the outstroke circuit and overall performance. The user interface 64 described above may facilitate this adjustment.

### Addressing Friction

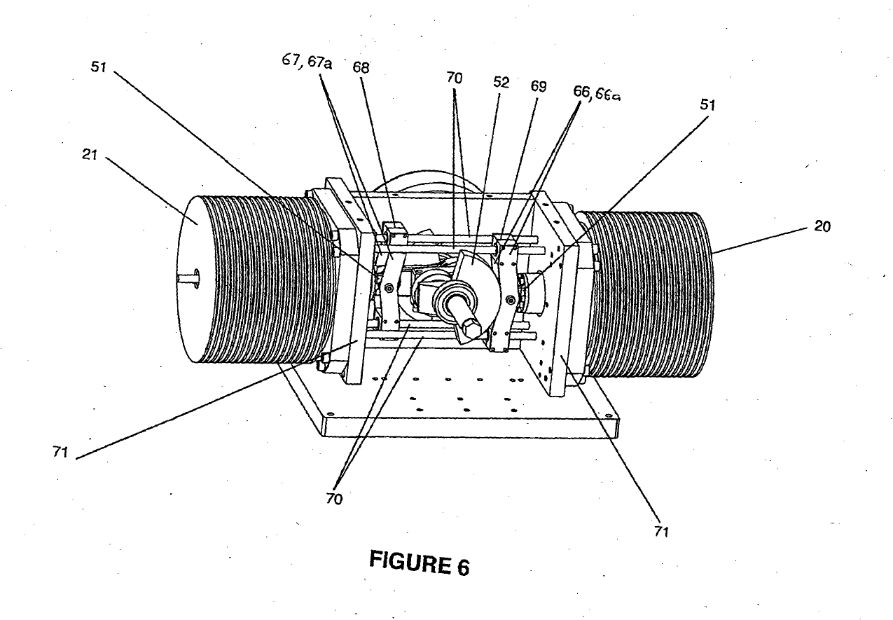

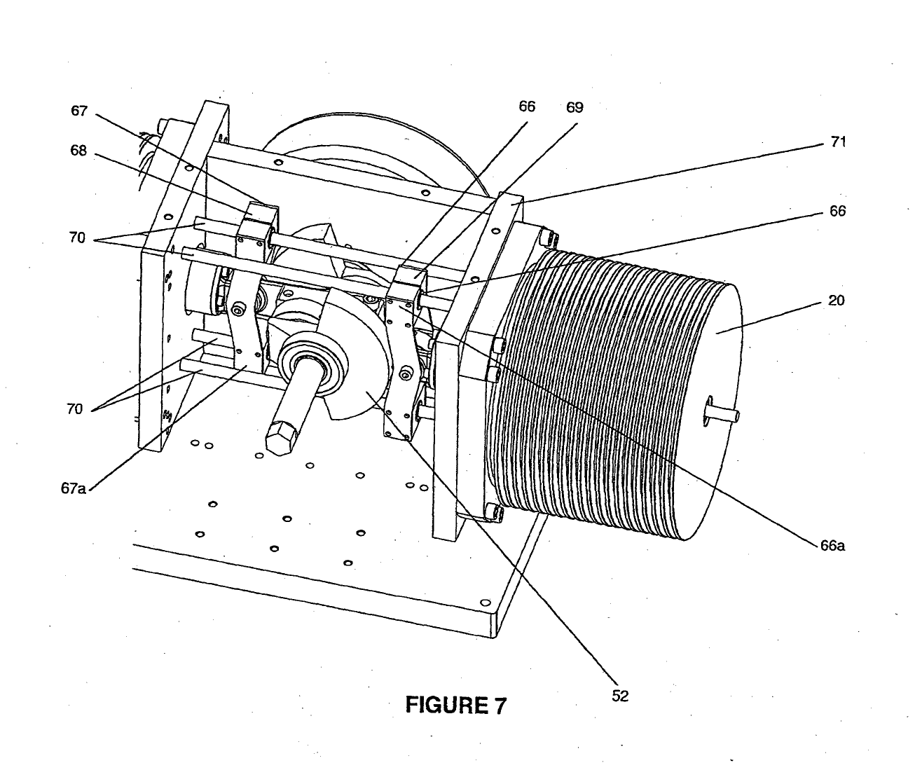

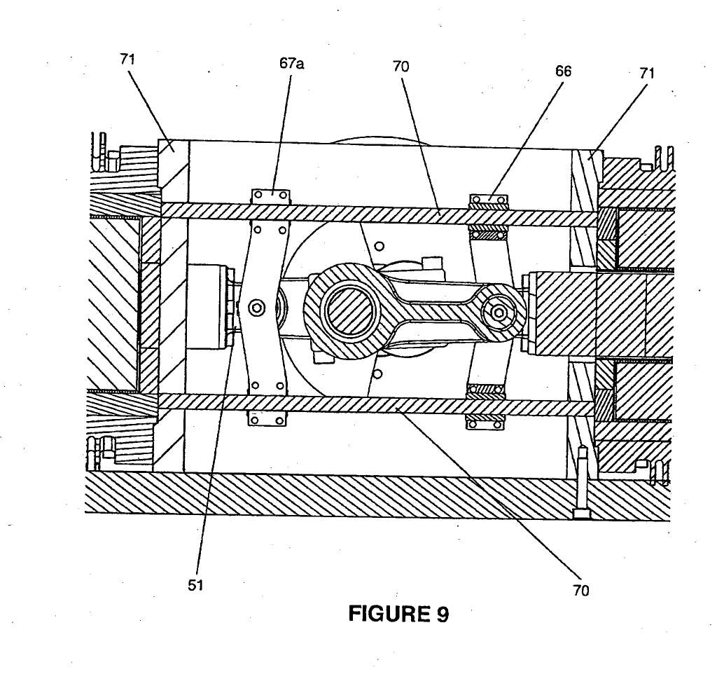

The embodiment of FIG. 1 comprises a solenoid driven motor that is, as noted above, in the configuration of a Horizontally Opposed Twin (HOT) drive mechanism as is evident from FIGS. 1 and 2. In one preferred embodiment of the HOT drive mechanism, a friction alleviation means is utilised and, in this respect, further reference is made to FIGS. 6 to 9.

The above description has made mention of reducing friction, as shown in FIG. 2, by a tubular sleeve 35 formed from a material having a low coefficient of friction, such as Teflon or PTFE, being interposed between the stationary coil assembly and the reciprocating plunger assembly where sleeve 35 may include a plurality (e.g. six) of radially projecting longitudinal splines along its inner surface to substantially reduce contact area between the reciprocating plunger assembly and sleeve 35. In contrast; the embodiment shown in FIGS. 6 to 9 provides a friction solution with the use of linear bearings. Preferably, the linear bearings comprise ceramic material but may comprise any suitable material as would be appreciated by the person skilled in the art. There are two bearings 66, 67 at the base of the plunger assembly, attached to the plunger assembly with brackets 66a, 67a that are themselves secured to the gudgeon pin 51 at the base of the clevis 49, which is itself attached to the plunger. The brackets are in a “boomerang” shape. The brackets attach to two bearing blocks 68, 69 one at the top and one at the bottom of the brackets. The bearing blocks 68, 69 hold one linear bearing 66, 67 each. Each linear bearing 66, 67 slides along a hardened steel rod 70 that runs along the axis of the plunger and between each crankcase end plate 71.

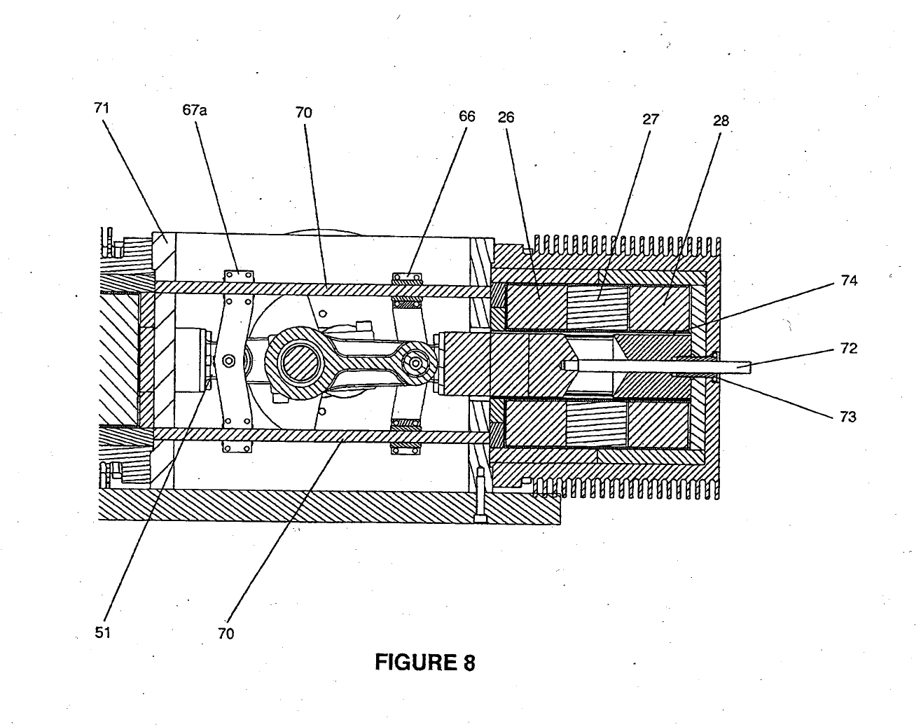

As best shown in FIG. 8, for supporting the tip of the plunger a hardened steel rod 72 is attached that runs from the tip and all the way up and through the solenoid core. On the outside of the core a single linear bearing 73 is secured through the solenoid outer housing. The rod is supported by the bearing and does not rub against any other part of the assembly as the rod extends through an aperture in the outer casing. The plunger is also wrapped in steel shim (not shown) to make it more rigid and better support the steel rod tip 72.

A thin bronze tube 74 is inserted between the coils 26, 27, 28 and the plunger assembly. Its purpose is to support the coil orientation and prevent the plunger from touching any of the coils. This tubing 74 may be the same tube as mentioned in the paragraphs above that describe the first mentioned friction solution but, with the raised splines bored out to give the plunger clearance of about 0.5 mm all around its circumference.

### Coil Control Alternative

Description has been provided above for “ideal waveforms” associated with the current pulses produced by one embodiment of the driver circuit with reference to FIGS. 3 and 4. It is to be noted that the above waveforms of FIGS. 4 and 5 relate to the operation of three coils within a solenoid according to one embodiment of the invention. The coils are “operated” using a series of DC pulses. Accordingly, the coil(s) are energised with an initial pulse and the resultant magnetic field moves the plunger(s) in a direction that is dependent on the coil field polarity. It has been identified by the inventor that what appears to work best is that the coil(s) is/are energised as quickly as possible to get the fastest current rise that can be achieved. Presently the initial pulse generally takes about 15 ms to about 25 ms, but this is dependent on the speed the motor is running at and the level of load the motor is driving.

The beginning of these initial pulses used to charge the coil(s) is at TDC or BDC. The polarity of the pulse required depends on whether the plunger is at TDC or BDC. Despite the pulse polarity, the basic coil control may be considered the same in either direction of plunger travel.

In this alternative embodiment, once the initial pulse has been delivered the next step is to attenuate the current being supplied from the driver circuit to the at least one coil. This can be achieved as follows.

Once having achieved the desired initial level of current running through the coil(s), the coil(s) is/are then short circuited, which allows the existing current to continue to flow. Short circuiting of the coils is only performed for a relatively small amount of time, for example, about 2 ms to about 5 ms. The current will start to fall due to the resistance in the copper windings, however it falls slower than compared to simply switching the coils off (ie throwing the circuit open) and this is the desired effect and is coined by the inventor as “freewheeling”, as noted above. During the freewheeling phase no power is being fed into the coils, however the coil magnetic field is still comparable to its value in the initial energising phase and therefore is still causing the plunger to move.

Once the freewheeling phase has allowed the current to drop a small amount, say about 5-10% of the initial current amplitude, the coil(s) is re-energised for a short time, for example, about a few ms and the current level is increased back up to approximately from where it had declined. This takes a very small amount of energy to “top up the current” as the amplitude difference is quite small and the level of impedance from inductance is also small relative to the initial energising pulse. Following this, the freewheeling is repeated and the plunger still continues to move. Following this, the coil(s) is reenergised again as the plunger continues to still move.

Once roughly 50% of the plunger stroke distance has been covered, the coil circuit is freewheeled for the next 25% to 30% of plunger movement and then thrown open and the naturally occurring current decays close to about 0 A at about the point when the plunger is hitting TDC or BDC as the plunger continues to still move.

The above procedure is then repeated for the next movement of the plunger, but using the reverse polarity of the half stroke just completed.

This driving procedure still works well if there is still current in the coil(s) when the plunger hits TDC or BDC as it is possible to recycle any energy left in the coils by capturing it, for example, in the capacitor of the storage module 61 and using that energy as part of the next initial energising phase for the coil(s).

The peak current is determined by the coil resistance, inductive impedance and coil size (relative to voltage being applied), where the coil size is predicated by wire thickness and the number of turns of wire in the coil. The initial pulse rise times are also determined by these same parameters.

In simple terms, a magnetic field is being maintained for the smallest amount of energy input that can be achieved for the purpose of moving a plunger. Each time the system is in the freewheeling phase there is still a fairly strong field that is moving the plunger, but there is no input of energy during that freewheeling phase. Even when the pulse train has completed, the falling current in the coils is still providing a magnetic field, although diminishing in strength.

The number of pulses for the “in-stroke” of the plunger and the “out-stroke” of the plunger can differ. This can be the case given that there are different inductance characteristics between the two strokes. On the in-stroke the inductance is rapidly increasing due to the closing air-gap between the plunger and the solenoid core. This is not necessarily occurring for the out-stroke as the air-gap is increasing between the plunger and the solenoid core. It has been found that a longer pulse train works best for the out-stroke (say 5 pulses in total) and a shorter pulse train works better for the in-stroke (say 3 pulses in total). Also, when moving through the final “decay” phase, the current decays slower in the out-stroke phase than it does during the in-stroke phase.

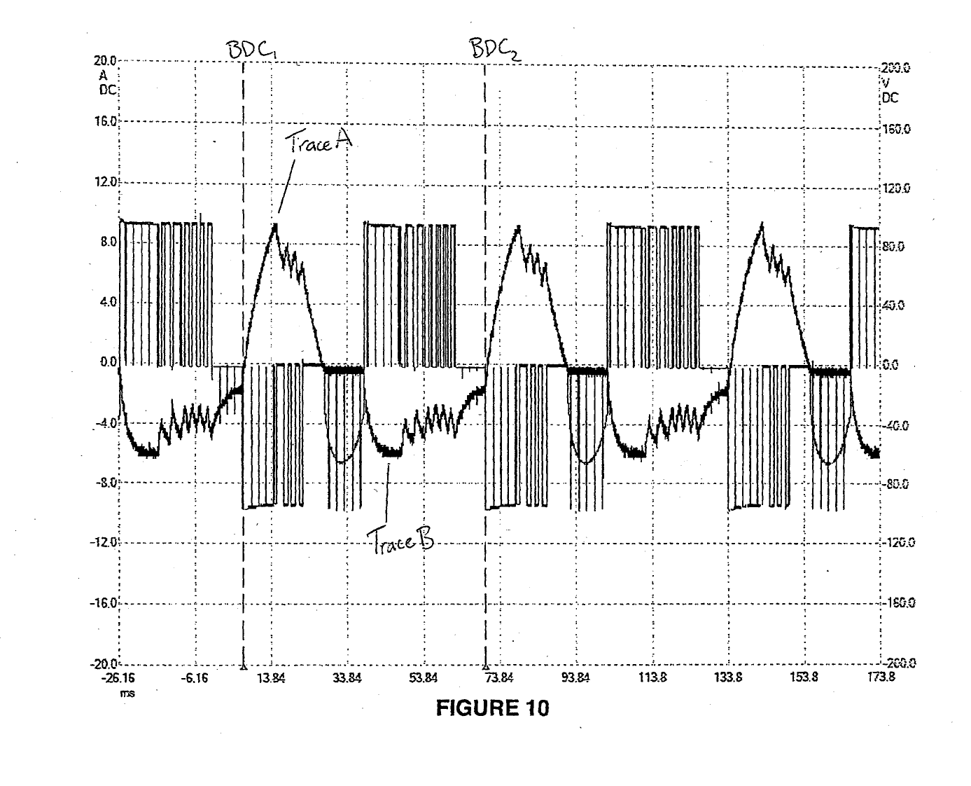

FIG. 10 displays an actual scope trace of a single coil going through the process above, noting that the pattern repeats in the trace of FIG. 10.

Trace A of FIG. 10 is the current through a typical coil 2 in the solenoid 1. The vertical dotted lines define a single revolution, as shown for example between BDC₁ being reached in one cycle to the following BDC₂ position of the plunger assembly. The vertical dotted line to the left is showing the BDC₁ position just where the plunger is starting to move towards TDC. The vertical dotted line to the right shows the same position, therefore it represents a single full revolution of the motor relative to the left-hand dotted line. Above the 0 A mark on the X-axis is the in-stroke as per Trace A. Below that mark the out-stroke is depicted by Trace B.

It is evident from FIG. 10 that the initial “in-stroke” pulse peaks at about 9 A and takes about 9 ms to reach that peak. Then the current falls to a bit over 6.3 A, ie freewheeling. Then the current jumps back to 7.8 A for the short pulse energise phase. Then another freewheel followed by a short pulse, then another freewheel followed by the final short pulse finishing at a little under 7 A. What follows is the coil circuit going open and the current falls to 0 A. The current stays at 0 A for a small time and where it starts to move below 0 A is the beginning of the “out-stroke” phase and its series of pulses/freewheels.

The whole single revolution cycle takes about 63.4 ms which is about 15.77 Hz, or 946 rpm. These times change depending on voltage applied, load and speed.

The out-stroke in this example has 7 pulses as opposed to 4 pulses in the in-stroke phase. Because it is below 0 A (opposite polarity to the in-stroke), the pulses and freewheels are opposite in Y-axis orientation to the in-stroke. The number of pulses applied is exemplary and may be varied in other embodiments.

The above method of energising involving alternating pulsing and ‘freewheeling’ is applicable to any number of coil arrangements and plunger assemblies.

### Plunger Assembly Alternative

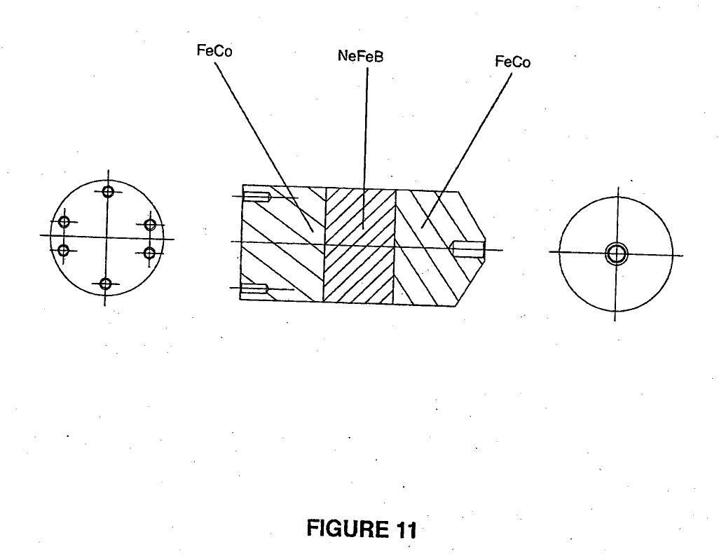

FIG. 11 illustrates a preferred form of plunger assembly that also is adapted for insertion of supporting rods. As noted in the above description, the or each magnetic plunger assembly may include at least three parts or sections. At least one part or section of the plunger assembly may include a relatively powerful permanent magnet. Preferably the or each permanent magnet includes a high grade (N42 or higher grade is preferred) rare earth magnet such as Neodymium (NdFeB) N52 grade magnet. For example, a 750 watt motor may require a high grade NdFeB magnet and a magnetic field that is about 1.2 T (tesla) or 12,000 Gauss in strength. In more general terms, in this embodiment there is provided a plunger assembly for a solenoid assembly, said solenoid assembly adapted for converting between electrical energy and mechanical movement and comprising a housing containing a core member and a coil assembly including at (east one coil, and a driver circuit for energizing said coil assembly to cause said plunger assembly to move at least between a first position and a second position, the plunger assembly comprising:

a first material portion comprising permanent magnetic material and;

a second material portion comprising material of high relative magnetic permeability, wherein the material of the first portion is located between material of the second portion. The second material portion may comprise two parts that are each placed at each respective end of the first material portion.

Effectively, the plunger comprises at least two materials, one being a strong permanent magnetic material, an exemplary material being NdFeB, and the other being a material of high relative magnetic permeability of about at least μ=4,500 to about p=9,000, an exemplary material being FeCo. Other ferrous material with suitably high permeability and saturation qualities may be considered. The relative magnetic permeability could run in a range from about μ=450 to about μ=20,000 or more depending on the material and motor design. The key is that it has to have high permeability and a saturation level higher than the magnetic fields being employed by the solenoid.

The plunger of this embodiment enhances the operation of a solenoid and in its use with an electric motor the plunger includes the addition of a rigid rod, preferably hardened steel, disposed from the conical tip of the plunger to the end of an outer casing of the motor for stabilising the plunger's reciprocal movement. Furthermore, a wrapping of thin plate, preferably steel shim, to make the plunger more rigid can mitigate the added mechanical forces that may be placed on the plunger by virtue of it being supported by the rigid rod.

### Scotch Yoke Arrangement

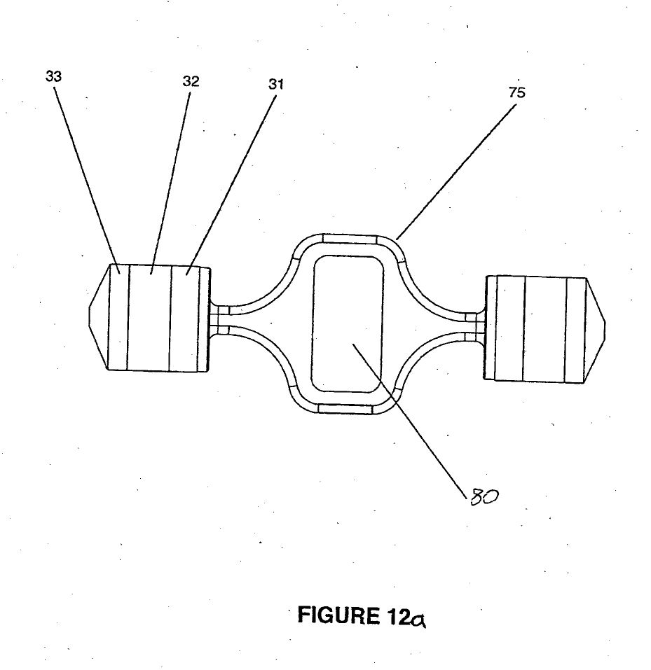

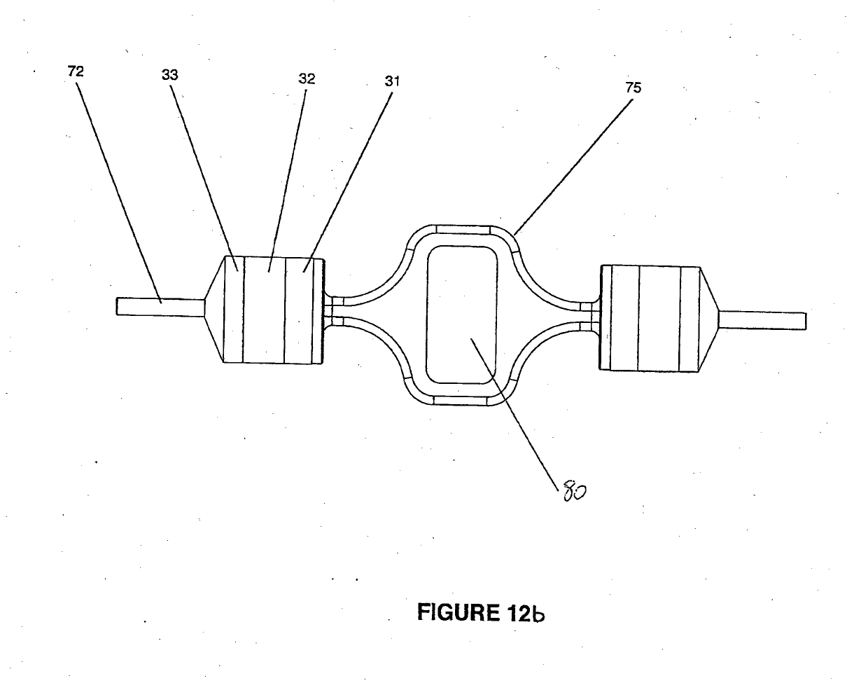

With reference to FIGS. 12 to 15 an alternate arrangement involves the use of at least one scotch yoke. The adaptation includes a scotch yoke 75 with a plunger at each side or end of the yoke as shown in FIG. 12a, for example.

As in the embodiments described above the plunger assembly is made up of a generally conical or frustoconical FeCo material cone, an NdFeB magnet and then a base also made from FeCo. In operation during one phase of motion the magnet within plunger portions or sections 31, 32, 33 on the left of FIG. 12 has its North pole facing to the left-hand direction of the drawing going through the tip of the plunger. In the event the field of the magnet on the right-hand side is oriented in exactly the same direction then the result we end up with is a total yoke and plunger assembly with a North polarity at one end and a South polarity at the other end forming one long magnet with the field concentrated at each tip of the respective plungers.

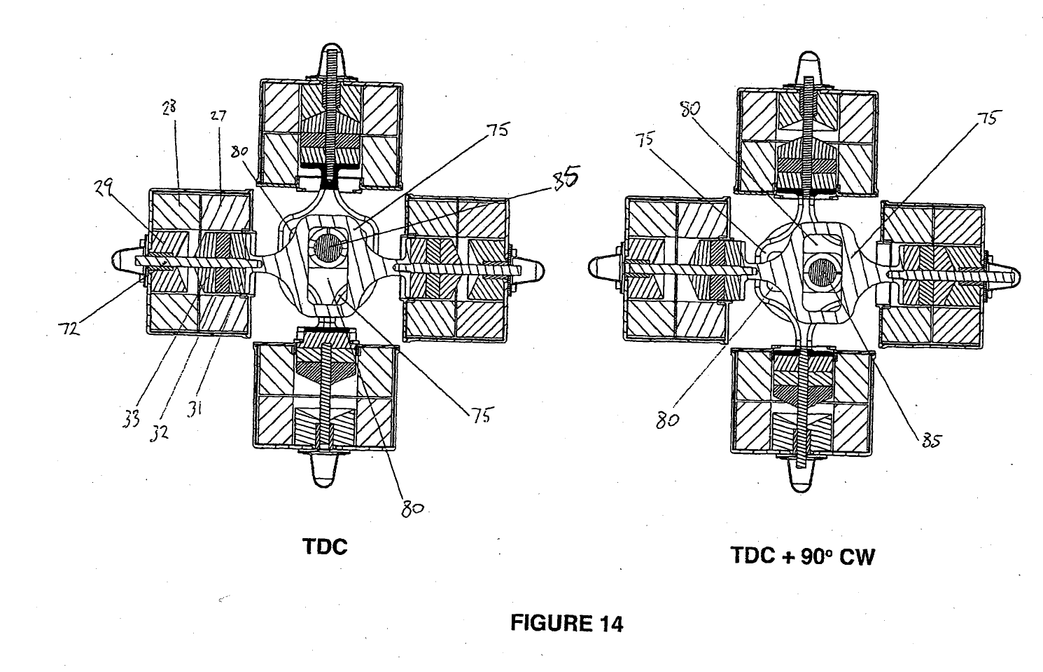

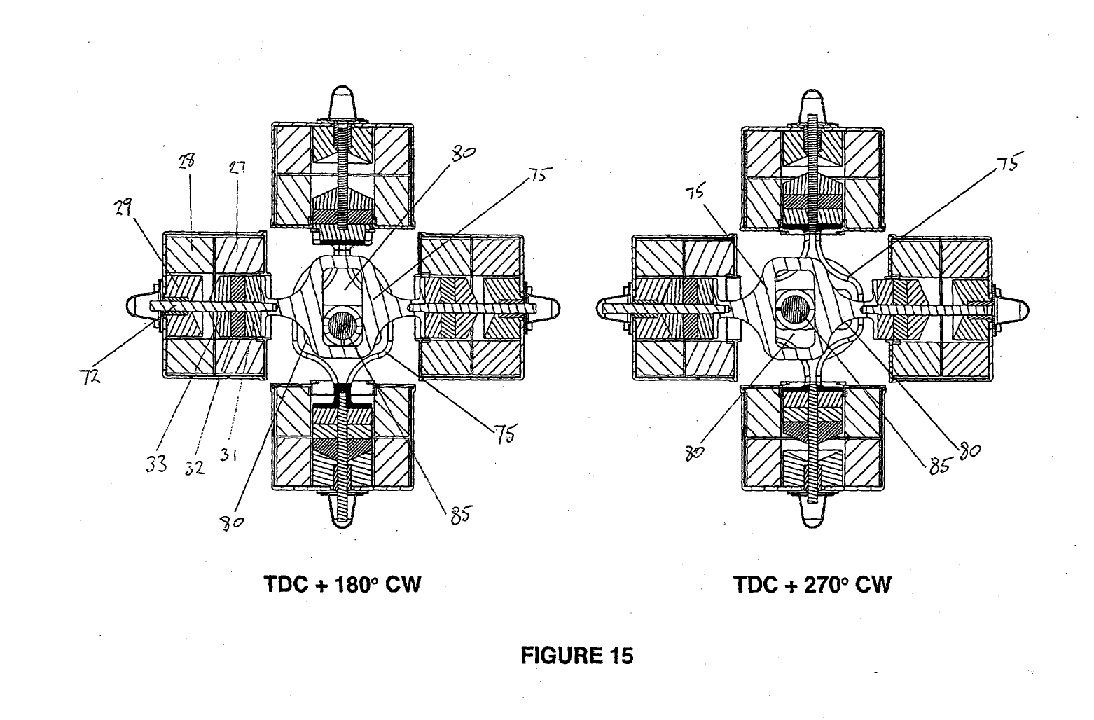

Taking a single yoke 75, when in motion it will move away from one solenoid and towards the opposite solenoid. The other yoke is doing the same thing, only at 90 degrees out of phase from the first yoke, however their respective fundamental actions are the same. This is shown best in FIGS. 14 and 15 as the motor goes through its cycle of motion. The operative connection of the plunger assembly 31, 32, 33 to a scotch yoke 75 provides rotational motion of the crankshaft by way of the reciprocating plunger assembly being directly coupled to a sliding yoke with a slot 80 that engages a pin as on the rotating crankshaft 45.

When moving away from a solenoid end the yoke is being repelled by the solenoid coil or coils by merit of the coil field polarity at the end the yoke is moving away from. At exactly the same time the end of the yoke moving towards a solenoid is being attracted by the coils in that solenoid by merit of the coil(s) polarity. One side pushes, the other pulls as a result. Once the yoke finishes its travel, both solenoid coil(s) polarities are reversed and the yoke travels back to where it started from. The yoke turns a crankshaft in this repeating process.

There may be at least one, two, three or more coils in each solenoid. The coils are controlled in basically the same fashion as described above in relation to preferred coil control methodology. The only difference with respect to the use of scotch yokes is the timing of the two solenoid pairs and their respective coils. The fact that there are two yokes makes little difference, it is just timing of pulses controlled by the electronics and determined by shaft position. By way of further explanation, in the HOT version a rotary encoder is attached to the shaft for determining timing. The TDC sensor is attached to the flywheel. In the present embodiment using a Scotch Yoke an “absolute position” sensor is used and therefore there is no need for a TDC indicator. In the employment of two scotch yokes separated and operated at 90° from each other, the timing difference between SY1 and SY2 is that they are energised 90° out of phase to each other. Also, for a single Scotch Yoke the bottom solenoid is repelling and the top solenoid is attracting, so they are different electrical polarities

There are a number of contrasting differences between the scotch yoke arrangement and the HOT version of embodiments described above. For example, no flywheel is required with the scotch yoke arrangement. The flywheel function is provided by the shaft counterweights (the rotating white “wings” in the centre of the animation) and partly by the yokes' phase difference inertia, which corresponds to the situation when one yoke is at the end of its stroke, the other yoke is at the middle of its stroke. This makes the mass inertia of the two yokes complimentary. There are linear bearings being used only at the tips of each rod extending from the plungers. The bearings at the base of the plunger utilised in one of the embodiments described above for the HOT version (and the rails that they run on) are no longer required in the scotch yoke arrangement. In a preferred embodiment, there are 4 “cylinders” instead of two. In this respect, using only one yoke would induce unacceptable vibration due to the entire mass of the yoke travelling in one direction at one time, whereas with two yokes disposed at 90° to each other the motions of the respective plungers are easily counterbalanced.

The hardened rod 72 described in embodiments above that runs from the tip of each plunger in the HOT version is now part of the yoke itself and runs through a hole in the centre of each plunger assembly. The rod 72 is preferably part of the yoke and moves with the yoke and plunger. Alternatively, the rod 72 may be attached or connected to the outer casing such that the plunger may move along the rod 72. It is also envisaged that the rod 72 could be connected or attached to the plunger, however, this may require a bearing arrangement on the outer casing to allow for relative movement of the rod 72 relative to the outer casing. This use of a hardened rod 72, particularly in the preferred arrangement where it is connected to the outer casing makes the assembly quite robust and stiff and removes the need for a steel shim wrapping around the plunger assembly.

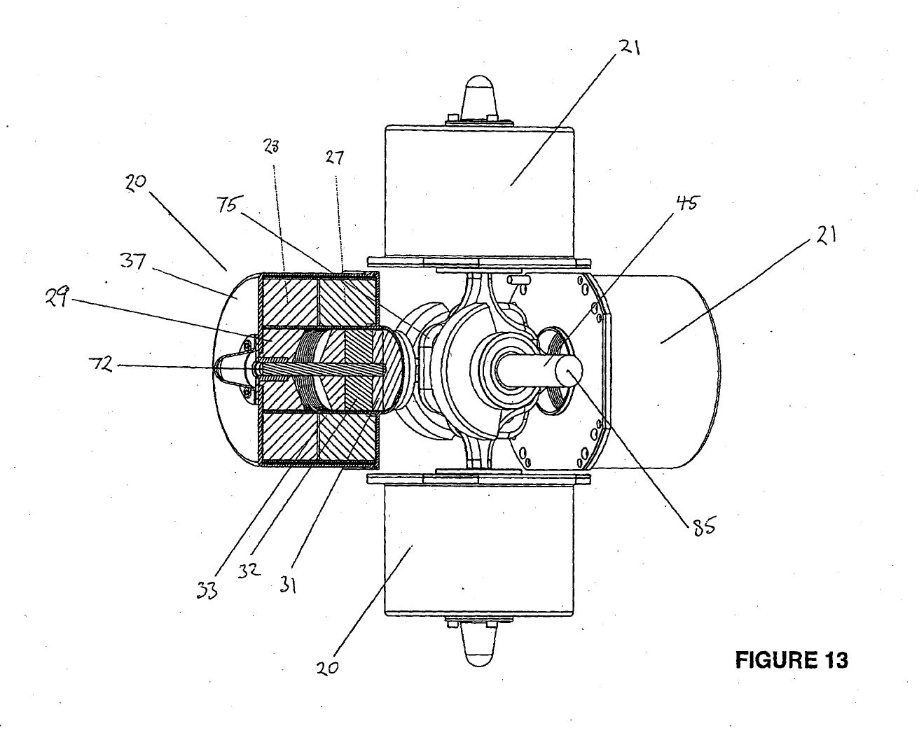

There are a number of advantages to the scotch yoke arrangement when compared to the HOT version. For example, it is more powerful due to the stronger magnetic circuit extending from one end of the yoke to the other. It is smaller and lighter than the HOT version. The two yokes being 90 degrees out of phase creates almost perfect balance. The force is applied in the exact direction of the yoke movement, whereas with the HOT version there are con-rods that interject at an angle between the plunger and the shaft being turned, which induce torque in a transverse direction that produces wasted vibrations. Fewer bearings are required in the scotch yoke arrangement and it is fully scalable down and up and can be made modular so that multiple units can be placed on one shaft to double/triple motor output. The machine can be started from any position because at any time at least one yoke is not touching a solenoid core. As opposed to outer casing. 37 depicted in FIGS. 1 and 2, with the scotch yoke arrangement of FIGS. 12 and 13 there is no need to include a plurality of radially extending fins around its circumference to facilitate or at least enhance dissipation of heat from the solenoid assembly because there is little heat produced by the coils. However, in other embodiments cooling fins along the lines as shown in FIGS. 1 and 2 may be employed in the scotch yoke arrangement.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

Various embodiments of the invention may be embodied in many different forms, including computer program logic for use with a processor (e.g., a microprocessor, microcontroller, digital signal processor, or general purpose computer and for that matter, any commercial processor may be used to implement the embodiments of the invention either as a single processor, serial or parallel set of processors in the system and, as such, examples of commercial processors include, but are not limited to Merced™, Pentium™, Pentium IIT™, Xeon™, Celeron™, Pentium Pro™, Efficeon™, Athlon™, AMD™ and the like), programmable logic for use with a programmable logic device (e.g., a Field Programmable Gate Array (FPGA) or other PLD), discrete components; integrated circuitry (e.g., an Application Specific Integrated Circuit (ASIC)), or any other means including any combination thereof. In an exemplary embodiment of the present invention, predominantly all of the communication between users and the embodying apparatus is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML. Moreover, there are hundreds of available computer languages that may be used to implement embodiments of the invention, among the more common being Ada; Algol; APL; awk; Basic; C; C++; Conol; Delphi; Eiffel; Euphoria; Forth; Fortran; HTML; Icon; Java; Javascript; Lisp; Logo; Mathematica; MatLab; Miranda; Modula-2; Oberon; Pascal; Perl; PL/I; Prolog; Python; Rexx; SAS; Scheme; sed; Simula; Smalltalk; Snobol; SQL; Visual Basic; Visual C++; Linux and XML.) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g, a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Hardware logic may also be incorporated into display screens in implementing embodiments of the invention and which may be segmented display screens, analogue display screens, digital display screens, CRTs, LED screens, Plasma screens, liquid crystal diode screen, and the like.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

I claim:

1.-54. (canceled)

55. A solenoid assembly adapted to convert between electrical energy and mechanical movement, said solenoid assembly comprising;
a housing containing a core member and a coil assembly including at least one coil;
a plunger assembly adapted for reciprocal movement within said housing between a first position and a second position; and
a driver circuit for energizing said coil assembly with alternating coil field polarities characterised by control means to adapt the driver circuit for energising said coil assembly with at least one initial pulse of current and a predetermined number of subsequent pulses of current to cause said plunger assembly to move at least between said first and second positions.

56. A solenoid assembly as claimed in claim 55 wherein the at least one initial pulse of current and the predetermined number of subsequent pulses of current magnetically interact with the core member so as to form an attracting or repulsing magnetic field between the core member and the plunger assembly dependent on the coil field polarity.

57. A solenoid assembly according to claim 55 wherein said coil assembly includes at least three coils, each coil being adapted to be energized separately or collectively via said driver circuit.

58. A solenoid assembly according to 55 wherein said driver circuit is adapted to generate a plurality of current pulses.

59. A solenoid assembly according to claim 58 wherein said current pulses include instroke and outstroke current pulses.

60. A solenoid assembly according to claim 59 wherein each instroke current pulse is applied to each coil in said coil assembly during movement of said plunger assembly between said first and said second positions.

61. A solenoid assembly according to claim 59 wherein each instroke current pulse reaches peak current within approximately 25% of its duration and decays to zero current before said plunger assembly reaches said second position.

62. A solenoid assembly according to claim 59 wherein each instroke current pulse peaks at approximately 4 amperes.

63. A solenoid assembly according to claim 59 wherein each outstroke current pulse is applied to at least one coil in said coil assembly during movement of said plunger assembly between said second and said first positions.

64. A solenoid assembly according to claim 59 wherein each outstroke current pulse reaches peak current within approximately 11% of its duration and decays to zero current before said plunger assembly reaches said first position.

65. A solenoid assembly according to claim 59 wherein each outstroke current pulse peaks at approximately 5 amperes.

66. A solenoid assembly according to claim 55 wherein said driver circuit is implemented via digital control including PWM.

67. An electric machine incorporating at least one pair of solenoid assemblies according to claim 55.

68. A method of energizing a solenoid assembly adapted to convert between electrical energy and mechanical movement, the solenoid assembly comprising a housing containing a core member and a coil assembly including at least one coil;
a plunger assembly adapted for reciprocal movement within said housing between a first position and a second position; and
a driver circuit for energizing said coil assembly with alternating coil field polarities to cause said plunger assembly to move at least between said first and second positions, the method comprising the steps of:
a) supplying at least an initial current pulse from the driver circuit to the at least one coil to produce a magnetic field in the housing of the solenoid assembly to magnetically interact with the core member so as to cause an attracting or repelling magnetic field between the core member and the plunger assembly dependent on the coil field polarity to cause the plunger assembly to move between the first and second position.

69. A method as claimed in claim 68 further comprising the steps of:
b) attenuating the current supplied from the driver circuit to the at least one coil for a relatively short period of time;
c) re-energizing the at least one coil with a further current pulse from the driver circuit.

70. A method as claimed in claim 69 wherein step b) further comprises maintaining a current residing in the at least one coil from the initial current pulse during the step of attenuating such that a magnetic field comparable to the field produced from the initial current pulse remains present for causing the plunger assembly to move between the first and second position.

71. A method as claimed in claim 70 further comprising the steps of:
d) repeating steps a) to c) a first predetermined number of times for about 50% of the movement of the plunger assembly between the first and second position and;
e) once the plunger assembly has moved to the second position, repeating steps a) to c) a second predetermined number of times for moving the plunger assembly between the second and first position;
wherein the polarity of current pulses in steps a) to d) is opposite the polarity of current pulses in step e) to induce reciprocal movement of the plunger assembly between the first and second positions, respectively;
wherein the relatively short period of time in step b) is between about 2 ms and about 5 ms;
wherein the attenuating in step b) is caused by short circuiting the at least one coil; and
step c) is applied after step b) when current residing in the at least one coil has been attenuated by between about 5% to about % N.

72. Apparatus for converting between electrical energy and mechanical movement including:
a housing comprised of a coil assembly and a core;
a plunger assembly adapted for movement through the housing between a first position and a second position, and;
motion assisting means for physically assisting the motion of at least a magnetised portion of the plunger assembly as a function of location between the first and second positions.

73. Apparatus according to claim 72 wherein the motion assisting means includes one or a combination of:
a driver circuit adapted for pulsing at least one current applied to the coil assembly at predetermined intervals;
a gradient of magnetic permeability to the material of one or a combination of the housing and the plunger assembly;
a flywheel operatively connected to the plunger assembly adapted for storing angular momentum.
